(19) United States
(12) Patent Application Publication
(10) Pub. No.: US 2014/0368321 A1
(43) Pub. Date: Dec. 18, 2014

(54) ULTRA-WIDEBAND RANGING WAVEFORM

(71) Applicant: Qualcomm Incorporated, San Diego, CA (US)

(72) Inventors: June NAMGOONG, San Diego, CA (US); Srikant JAYARAMAN, San Diego, CA (US)

(21) Appl. No.: 13/916,329

(22) Filed: Jun. 12, 2013

(51) Int. Cl. G01S 3/04

(52) U.S. Cl. CPC G01S 3/04
USPC 340/10.5

(57) ABSTRACT

Methods, systems, devices, and apparatuses are described for location tracking in which each tag used to track an asset or person in an indoor environment transmits ranging waveforms used to estimate a location of the tag. Multiple tags may concurrently transmit without interfering with each other by having each tag use a distinct frequency shift for the ranging waveforms. Access points may be deployed throughout the indoor environment as part of a wireless network (e.g., ultra-wideband or UWB network) that tracks the assets. The access points may receive the ranging waveforms transmitted by the tags and may perform measurements based on the ranging waveforms. The measurements may be sent to a tracking management server to estimate the location of the tags. The server may also determine and assign the distinct frequency shifts used by the tags and may modify the assignment when the number of tags being tracked changes.

### BACKGROUND

In some settings, such as in indoor and enterprise environments, for example, it may be important to easily locate various types of assets and/or persons. Examples of such settings include hospitals, retail stores, and warehouses. One type of asset to be tracked may be expensive medical, scientific, or industrial equipment that is generally moved between locations within the indoor environment. The accuracy and speed with which the location of an asset or person is monitored may be critical in determining the usefulness of the tracking system. In addition, there may be situations in which the number of assets or persons to be tracked is quite large and the system may need to effectively support those situations.

Different systems and devices may be used to locate assets and/or persons in a particular indoor environment. In one example, a radio frequency network deployed throughout at least a portion of the indoor environment may be used to perform indoor tracking. The network may include multiple access points (APs) placed at specific locations in the indoor environment. In addition to the APs, tags or tag units may be attached to each mobile asset and/or to each person to be tracked. In operation, the tag may send ranging waveforms (e.g., preamble or beacon signals) that are received by the APs to make ranging measurements, that is, to determine the distance between the tag and the APs that receive the waveforms. Once the distances between the tag and at least three or four different APs are obtained, triangulation or trilateration may be performed to estimate the location of the asset or person attached to the tag.

In a typical scenario, many tags may be concurrently transmitting ranging waveforms because there are multiple assets being tracked at the same time. However, when ranging waveforms from multiples tags are transmitted at the same time, the ranging waveforms from the tags are likely interfere with each other and the ranging measurements for each tag becomes difficult to make, affecting the accuracy of the estimates of where the tags are located. Therefore, this type of interference may restrict the capacity of an indoor tracking system by limiting the number of tags that can be tracked at the same time.

Thus, to achieve tracking that accurately monitors a large number of assets and/or persons at the same time, it may be desirable to use systems, methods, devices, and apparatuses that enable the use of ranging waveforms that provide significant isolation between concurrent transmissions from multiple tags.

### SUMMARY

Methods, systems, devices, and apparatuses are provided that may address problems pertaining to effective asset and/or persons tracking in an indoor environment. An indoor tracking system is described in which tags or tag units are used to track multiple assets or persons. Each of the tags transmits ranging waveforms used to estimate a location of the tag and its corresponding asset or person. Multiple tags may concurrently transmit without interfering with each other by having each of the tags use a distinct frequency shift for the ranging waveforms. Access points (APs) may be deployed throughout the indoor environment as part of a wireless network (e.g., ultra-wideband or UWB network) that tracks the assets. The APs may receive the ranging waveforms transmitted by the tags and may perform measurements (e.g., distance or ranging measurements) based at least in part on the ranging waveforms. The measurements may be sent to a tracking management server or other similar network entity to estimate the location of the tags. The server may also be used to register the tags, and to determine and assign the distinct frequency shifts used by the tags. The distinct frequency shifts that are assigned to the tags may be based, at least in part, on the number of tags being tracked. Thus, the server may modify a current frequency shift assignment (e.g., may use new frequency shifts) when the number of tags changes because the number of assets and/or persons that are being tracked changes.

A method for location tracking includes assigning to each tag in a set of tags a distinct frequency shift associated with ranging waveforms, where each of the tags in the set is attached to a different asset or person being tracked. The method also includes receiving the ranging waveforms from one or more of the tags in the set, where the ranging waveforms are transmitted by the one or more tags using the assigned distinct frequency shifts. The method further includes determining a location estimate for the one or more tags based at least in part on the ranging waveforms. In some embodiments, the method includes receiving one or more UWB signals having the ranging waveforms. The distinct frequency shift assigned to each of the tags in the set may be based on a total number of tags in the set. The ranging waveforms may be concurrently received during a specified time slot assigned to the tags in the set. The frequency shift assigned to each of the tags in the set may be based on a period of a pseudo-random noise (PN) sequence used in the ranging waveforms. The PN sequence corresponding to one of the tags in the set may be different from the PN sequence corresponding to another tag in the set. The frequency shift assigned to each of the tags in the set may be inversely proportional to a period of the ranging waveforms. The set of tags may correspond to a first specified time slot, and a different set of tags may correspond to a second specified time slot different from the first specified time slot.

In some embodiments, determining the location estimate for the one or more tags includes identifying an earliest path corresponding to one of the one or more tags based at least in part on the ranging waveforms received from the one tag, determining a ranging measurement corresponding to the one tag based at least in part on the identified earliest path, and determining the location estimate for the one tag based at least in part on the ranging measurement. In some embodiments, the method also includes identifying a change in the number of tags in the set, and assigning to each tag in the set a new distinct frequency shift associated with the ranging waveforms, where each new distinct frequency shift is based at least in part on the identified change in the number of tags.

A method for location tracking includes receiving an assignment for a tag in a set of tags, where the assignment includes a frequency shift for transmission of ranging waveforms to one or more access points, and where the frequency shift is distinct for each of the tags in the set. The method also includes transmitting the ranging waveforms using the frequency shift for the tag. In some embodiments, transmitting the ranging waveforms includes transmitting one or more UWB signals having the ranging waveforms. In some embodiments, the method also includes receiving a new assignment for the tag, where the new assignment includes a new frequency shift for transmission of the ranging waveforms that is distinct from a new frequency shift assigned to the other tags in the set, and where the new frequency shift for the tag is received in response to a change in the number of tags in the set. The method further includes transmitting the ranging waveforms using the new frequency shift for the tag.

A method for location tracking includes assigning to each tag in a set of tags a distinct frequency shift associated with ranging waveforms, where the distinct frequency shift for each tag is an integer multiple of (1/LNT), where L is a total number of tags in the set and NT is a period of the ranging waveforms prior to the application of the distinct frequency shifts. In some embodiments, the method includes assigning a new distinct frequency shift to each tag in the set in response to a change in the number of tags in the set.

An apparatus for location tracking includes means for assigning to each tag in a set of tags a distinct frequency shift associated with ranging waveforms, where each of the tags in the set is attached to a different asset or person being tracked. The apparatus also includes means for receiving the ranging waveforms from one or more of the tags in the set, where the ranging waveforms are transmitted by the one or more tags using the assigned distinct frequency shifts. The apparatus further includes means for determining a location estimate for the one or more tags based at least in part on the ranging waveforms. In some embodiments, the apparatus includes means for receiving one or more UWB signals having the ranging waveforms. The distinct frequency shift assigned to each of the tags in the set may be based on a total number of tags in the set. The ranging waveforms may be concurrently received during a specified time slot assigned to the tags in the set. The frequency shift assigned to each of the tags in the set may be based on a period of a PN sequence used in the ranging waveforms. The PN sequence corresponding to one of the tags in the set may be different from the PN sequence corresponding to another tag in the set. The frequency shift assigned to each of the tags in the set may be inversely proportional to a period of the ranging waveforms. The set of tags may correspond to a first specified time slot, and a different set of tags may correspond to a second specified time slot different from the first specified time slot.

In some embodiments, the means for determining the location estimate for the one or more tags includes means for identifying an earliest path corresponding to one of the one or more tags based at least in part on the ranging waveforms received from the one tag, means for determining a ranging measurement corresponding to the one tag based at least in part on the identified earliest path, and means for determining the location estimate for the one tag based at least in part on the ranging measurement. In some embodiments, the apparatus also includes means for identifying a change in the number of tags in the set, and means for assigning to each tag in the set a new distinct frequency shift associated with the ranging waveforms, where each new distinct frequency shift is based on the identified change in the number of tags.

An apparatus for location tracking includes means for receiving an assignment for a tag in a set of tags, where the assignment includes a frequency shift for transmission of ranging waveforms to one or more access points, and where the frequency shift is distinct for each of the tags in the set. The apparatus also includes means for transmitting the ranging waveforms using the frequency shift for the tag. In some embodiments, the means for transmitting the ranging waveforms includes means for transmitting one or more UWB signals having the ranging waveforms. In some embodiments, the apparatus also includes means for receiving a new assignment for the tag, where the new assignment includes a new frequency shift for transmission of the ranging waveforms that is distinct from new frequency shifts assigned to the other tags in the set, and where the new frequency shift for the tag is received in response to a change in the number of tags in the set. The apparatus further includes means for transmitting the ranging waveforms using the new frequency shift for the tag.

An apparatus for location tracking includes means for assigning to each tag in a set of tags a distinct frequency shift associated with ranging waveforms, where the distinct frequency shift for each tag is an integer multiple of (1/LNT), where L is a total number of tags in the set and NT is a period of the ranging waveforms prior to the application of the distinct frequency shifts. In some embodiments, the apparatus includes means for assigning a new distinct frequency shift to each tag in the set in response to a change in the number of tags in the set.

A system for location tracking includes one or more access points configured to receive ranging waveforms from one or more tags in a set of tags, where the ranging waveforms are transmitted by the one or more tags using a distinct frequency shift assigned to each of the tags in the set. The system also includes a server configured to assign to each tag in the set the distinct frequency shift associated with ranging waveforms, and to determine a location estimate for the one or more tags based at least in part on the ranging waveforms received by the one or more access points. The one or more access points may be configured to receive one or more UWB signals having the ranging waveforms. The distinct frequency shift assigned to each of the tags in the set may be based on a total number of tags in the set. The ranging waveforms may be concurrently received during a specified time slot assigned to the tags in the set. The frequency shift assigned to each of the tags in the set may be based on a period of a PN sequence used in the ranging waveforms. The PN sequence corresponding to one of the tags in the set may be different from the PN sequence corresponding to another tag in the set. The frequency shift assigned to each of the tags in the set may be inversely proportional to a period of the ranging waveforms. The set of tags may correspond to a first specified time slot, and a different set of tags may correspond to a second specified time slot different from the first specified time slot.

In some embodiments, the server, the one or more access points, or both are further configured to identify an earliest path corresponding to one of the one or more tags based at least in part on the ranging waveforms received from the one tag, to determine a ranging measurement corresponding to the one tag based at least in part on the identified earliest path, and to determine the location estimate for the one tag based at least in part on the ranging measurement. In some embodiments, the server is further configured to identify a change in the number of tags in the set and to assign to each tag in the set a new distinct frequency shift associated with the ranging waveforms, where each new distinct frequency shift is based at least in part on the identified change in the number of tags.

A device for location tracking includes a ranging module configured to receive an assignment for a tag in a set of tags, where the assignment includes a frequency shift for transmission of ranging waveforms to one or more access points, and where the frequency shift is distinct for each of the tags in the set. The device also includes a transmitter module configured to transmit the ranging waveforms using the frequency shift for the tag. The transmitter may be configured to transmit one or more UWB signals having the ranging waveforms. The ranging module may be configured to receive a new assignment for the tag, where the new assignment includes a new frequency shift for transmission of the ranging waveforms that is distinct from new frequency shifts assigned to the other tags in the set, and where the new frequency shift for the tag is received in response to a change in the number of tags in the set. The transmitter module may be configured to transmit the ranging waveforms using the new frequency shift for the tag.

A computer program product for location tracking includes non-transitory computer-readable medium having code for causing at least one computer to assign to each tag in a set of tags a distinct frequency shift associated with ranging waveforms, where each of the tags in the set is attached to a different asset or person being tracked. The non-transitory computer-readable medium also has code for causing the at least one computer to receive the ranging waveforms from one or more of the tags in the set, where the ranging waveforms are transmitted by the one or more tags using the assigned distinct frequency shifts. The non-transitory computer-readable medium also has code for causing the at least one computer to determine a location estimate for the one or more tags based at least in part on the ranging waveforms. In some embodiments, the non-transitory computer-readable medium has code for causing the at least one computer to receive one or more UWB signals having the ranging waveforms. The distinct frequency shift assigned to each of the tags in the set may be based on a total number of tags in the set. The ranging waveforms may be concurrently received during a specified time slot assigned to the tags in the set. The frequency shift assigned to each of the tags in the set may be based on a period of a PN sequence used in the ranging waveforms. The PN sequence corresponding to one of the tags in the set may be different from the PN sequence corresponding to another tag in the set. The frequency shift assigned to each of the tags in the set may be inversely proportional to a period of the ranging waveforms. The set of tags may correspond to a first specified time slot, and a different set of tags may correspond to a second specified time slot different from the first specified time slot.

In some embodiments, the non-transitory computer-readable medium also has code for causing the at least one computer to identify an earliest path corresponding to one of the one or more tags based at least in part on the ranging waveforms received from the one tag, code for causing the at least one computer to determine a ranging measurement corresponding to the one tag based at least in part on the identified earliest path, and code for causing the at least one computer to determine the location estimate for the one tag based at least in part on the ranging measurement. In some embodiments, the non-transitory computer-readable medium also has code for causing the at least one computer to identify a change in the number of tags in the set, and code for causing the at least one computer to assign to each tag in the set a new distinct frequency shift associated with the ranging waveforms, where each new distinct frequency shift is based at least in part on the identified change in the number of tags.

A computer program product for location tracking includes a non-transitory computer-readable medium having code for causing at least one computer to receive an assignment for a tag in a set of tags, where the assignment includes a frequency shift for transmission of ranging waveforms to one or more access points, and where the frequency shift is distinct for each of the tags in the set. The non-transitory computer-readable medium also has code for causing the at least one computer to transmit the ranging waveforms using the frequency shift for the tag. In some embodiments, the non-transitory computer-readable medium has code for causing the at least one computer to transmit one or more UWB signals having the ranging waveforms. In some embodiments, the non-transitory computer-readable medium also has code for causing the at least one computer to receive a new assignment for the tag, where the new assignment includes a new frequency shift for transmission of the ranging waveforms that is distinct from new frequency shifts assigned to the other tags in the set, and where the new frequency shift for the tag is received in response to a change in the number of tags in the set. The non-transitory computer-readable medium also has code for causing the at least one computer to transmit the ranging waveforms using the new frequency shift for the tag.

The foregoing has outlined the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A shows a diagram of an example of access point synchronization in a location tracking system according to various embodiments;

FIG. 1B shows a diagram of an example of concurrent transmission of ranging waveforms from multiple tags in a location tracking system according to various embodiments;

FIG. 2A shows a block diagram of an example of a ranging waveform device for a tag unit according to various embodiments;

FIG. 2B shows a block diagram of another example of a ranging waveform device for a tag unit according to various embodiments;

FIG. 3A shows a block diagram of an example of a tag unit according to various embodiments;

FIG. 3B shows a block diagram of another example of a tag unit according to various embodiments;

FIG. 4A shows a block diagram of an example of a ranging waveform device for an access point according to various embodiments;

FIG. 4B shows a block diagram of another example of a ranging waveform device for an access point according to various embodiments;

FIG. 5 shows a block diagram of an example of an access point for a location tracking system according to various embodiments;

FIG. 6A shows a block diagram of an example of a ranging waveform device for a tracking management server according to various embodiments;

FIG. 6B shows a block diagram of another example of a ranging waveform device for a tracking management server according to various embodiments;

FIG. 7 shows a block diagram of an example of a tracking management server according to various embodiments;

FIG. 8 is a flowchart of an example of a method for location tracking using distinct frequency shifts for each tag unit according to various embodiments;

FIG. 9 is a flowchart of another example of a method for location tracking using distinct frequency shifts for each tag unit according to various embodiments;

FIG. 10 is a flowchart of a yet another example of a method for location tracking using distinct frequency shifts for each tag unit according to various embodiments;

FIG. 11 is a flowchart of an example of a method for using a distinct frequency shift in a tag unit transmitting ranging waveforms according to various embodiments;

FIG. 12 is a flowchart of another example of a method for using a distinct frequency shift in a tag unit transmitting ranging waveforms according to various embodiments; and

FIG. 13 is a flowchart of an example of a method for assigning distinct frequency shifts to multiple tags according to various embodiments.

### DETAILED DESCRIPTION

Methods, systems, devices, and apparatuses are provided that may address problems pertaining to effective asset and/or persons tracking in an indoor environment. An indoor tracking system is described in which tags or tag units are used to track multiple assets or persons. Each of the tags transmits ranging waveforms used to estimate a location of the tag and its corresponding asset or person. Multiple tags may concurrently transmit without interfering with each other by having each of the tags use a distinct frequency shift for the ranging waveforms. APs may be deployed throughout the indoor environment as part of a wireless network (e.g., ultra-wideband or UWB network) that tracks the assets. The APs may receive the ranging waveforms transmitted by the tags and may perform measurements (e.g., distance or ranging measurements) based at least in part on the ranging waveforms. The measurements may be sent to a tracking management server or other similar network entity to estimate the location of the tags. The server may also be used to register the tags, and to determine and assign the distinct frequency shifts used by the tags. The distinct frequency shifts may be based, at least in part, on the number of tags being tracked by the system. Thus, the server may modify a current frequency shift assignment (e.g., may assign new frequency shifts) when the number of tags changes as the number of assets and/or persons that are being tracked changes.

The tags or tag units in an indoor tracking system typically use strong transmissions to be heard by the APs. The more APs that know of a particular tag, the easier it may be to track that tag and estimate its location. At least for this reason, tags tend not to use transmit power control mechanisms and, consequently, the strength of their transmissions may not be adjusted. The interference that occurs when multiple tags transmit ranging waveforms at the same time may result in part from the strong signals transmitted by the tags. To address this issue, one approach to follow may be to coordinate and schedule the transmissions of all the tags such that they take place at different times. This approach, however, may result in transmission bottlenecks for systems that have a large number of tags. Other approaches, such as feedback mechanisms for signal retransmission in the event of a collision may be too complex to implement in low-cost tracking tags.

Using a distinct frequency shift for each of the tags that transmit ranging waveforms at the same time, as noted above and further described below, may improve the performance and capacity of the indoor tracking system by reducing or eliminating interference between concurrent transmissions of ranging waveforms resulting in more accurate estimates of the locations of the tags being tracked.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

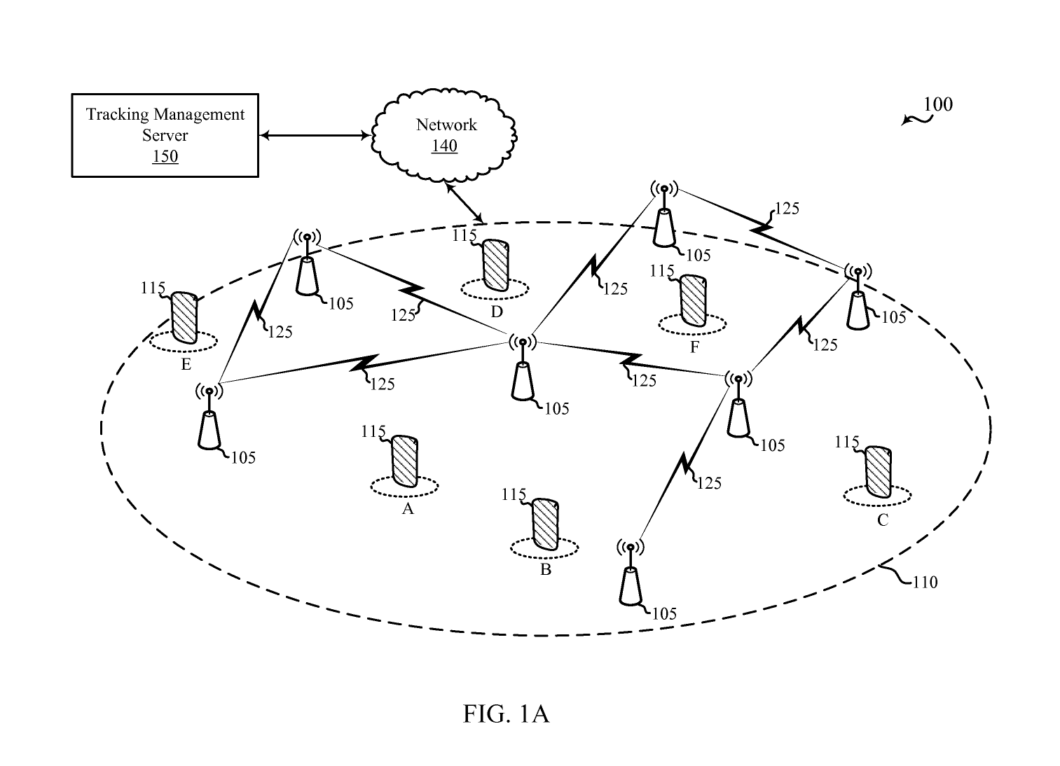

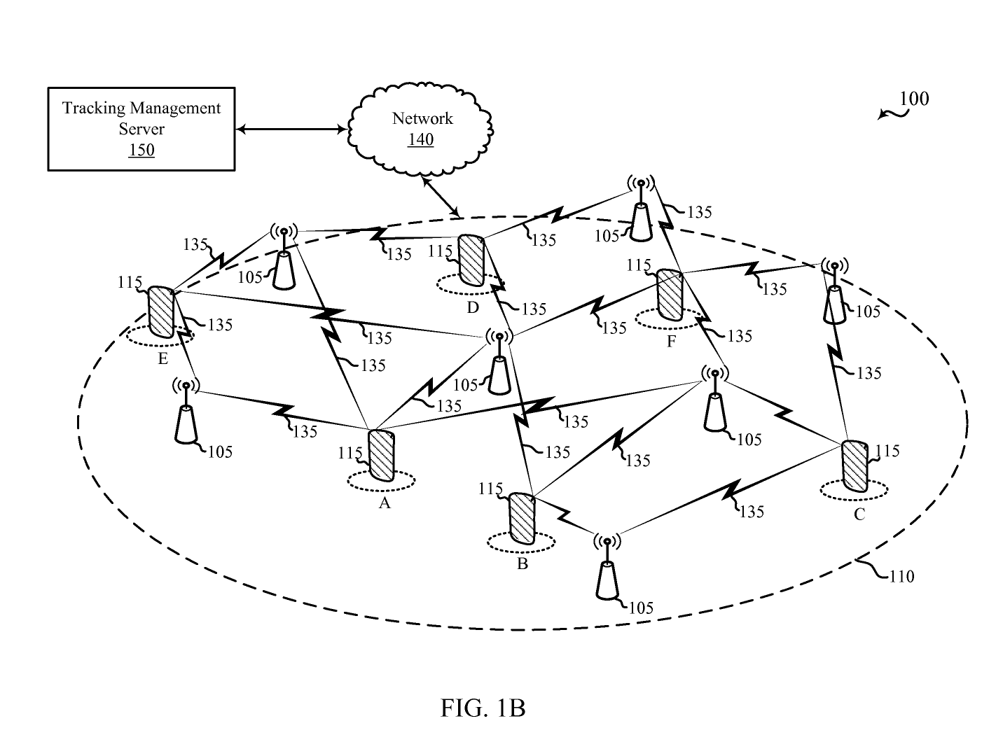

Referring first to FIG. 1A, a diagram illustrates an example of a location tracking system 100 in accordance with various embodiments. The system 100 provides location tracking of assets (e.g., objects) and/or persons across a coverage area 110 associated with an indoor or enterprise environment. For example, the coverage area 110 may represent an area of coverage inside a building, a hospital, a store, a warehouse, or some other facility or space. In the coverage area 110, there are deployed multiple APs 105 at specific locations and multiple tags or tag units 115 that may be tracked within the coverage area 110. Because of their stationary nature, the exact distance between any two APs 105 is typically known throughout the operation of the system 100.

The arrangement of APs 105 shown in FIG. 1A is provided by way of illustration and not of limitation. For example, the APs 105 may be deployed or distributed within the coverage area 110 in different ways from the pattern shown in FIG. 1A and at different distances from each other. Moreover, while the arrangement depicts a two-dimensional deployment, the APs 105 may also be deployed in a three-dimensional manner by placing some of the APs 105 in different floors or levels within the coverage area 110. In some embodiments, the APs 105 may be associated with a radio network such as an ultra-wideband (UWB) network, for example. One or more of the APs 105 in the network may be used as reference APs to synchronize some of the operations of the network. The APs 105 in the network may communicate with one or more nearby APs using transmissions 125 as illustrated in FIG. 1A.

Each of the tag units 115 may be attached to an assigned asset or person being tracked within the coverage area 110. In the example shown in FIG. 1A, there are six tag units 115 at locations A, B, C, D, E, and F. Over time, these locations may change as the assets or persons corresponding to the tag units 115 move or are moved within the coverage area 110. It should be understood that the number of tag units 115 is provided as illustrative and that the system 100 may be capable of tracking more or fewer assets or persons.

The system 100 includes a tracking management server 150 that is connected to the APs 105 (e.g., connected to a radio network associated with the APs 105s) through a network 140. The tracking management server 150 may receive information from the APs 105 to perform various types of calculations, including but not limited to distance calculations, clock offset calculations, and/or triangulation or trilateration calculations to estimate the location of an object or person being tracked within the coverage area 110. The tracking management server 150 may also schedule or coordinate various operations associated with the APs 105 including when to have an AP 105 wirelessly communicate (e.g., transmit or receive ranging waveforms) with another AP 105 to determine clock offsets between them in order to synchronize the operation of the system 100. The tracking management server 150 may have information about the locations of the APs 105 and may use this information when performing clock offset calculations. The tracking management server 150 may have information about different subsets of the APs 105 and may use that information to schedule or coordinate various operations between the subsets.

The tracking management server 150 may be used to register the tag units 115 in the system 100. The tracking management server 150 may also determine or identify a set of distinct frequency offsets to assign to the tag units 115 for use when transmitting ranging waveforms. For example, after the tag units 115 are registered with the tracking management server 150, the tracking management server 150 may determine or identify a set of distinct frequency offsets based at least in part on the number of registered tag units 115. The tracking management server 150 may then assign to each of the registered tag units 115 a distinct frequency offset from the set. In some instances, the assignment may occur wirelessly through one or more of the APs 105, although other mechanisms may also be used. Along with the assignment of the distinct frequency offsets, the tracking management server 150 may also assign to each registered tag unit 115 particular time slot(s) and/or a pseudo-random noise (PN) sequence for the transmission of ranging waveforms. Using distinct PN sequences for the tag units 115 may reduce the level of interference between concurrent transmissions of ranging waveforms. However, the number of distinct PN sequences with low cross-correlation that may be used is typically limited and the level of isolation achieved by using these PN sequences may also be limited. Therefore, in some embodiments, the use of a limited number of PN sequences with low cross-correlation may be combined with the use distinct frequency shifts when concurrently transmitting ranging waveforms from different tag units 115.

When the number of registered tag units 115 changes as more are added and/or some are removed from the system 100, the tracking management server 150 may determine or identify a new set of distinct frequency offsets and may assign those new frequency offsets to the current set of registered tag units 115. During this reassignment, the tracking management server 150 may also determine PN sequences and/or time slots to be used by the current set of registered tag units 115.

The APs 105 may receive wireless transmissions (e.g., ranging waveforms or preamble signals) from one or more of the tag units 115. The tag units 115 may periodically sends wireless transmissions to identify themselves to the system 100. The information from the wireless transmissions may be received by the APs 105, typically those closest to the tag units 115, and those APs 105 may collect, process, and store the information. For example, one of the APs 105 may use the information provided by one of the tag units 115 to determine a distance between that AP 105 and that tag unit 115. The distance calculation or measurement may be sent to the tracking management server 150 for further processing. In some embodiments, the AP 105 collects the information from the tag unit 115 and sends the information to the tracking management server 150 to perform the distance calculations and for further processing. The distance calculations from three or more APs 105 may be used by the tracking management server 150 to accurately estimate the location of the tag unit 115 within the coverage area 110.

An example of the operation of the system 100 of FIG. 1A is described next. The APs 105 are first synchronized by determining clock offsets between the APs 105 and reference APs. The synchronization may include transmitting signals (e.g., ranging waveforms) from one AP 105 to another AP 105 to determine the clock offsets between them. FIG. 1B shows that once the clock offsets are known and synchronization is achieved, range measurements between some of the APs 105 and the tag units 115 may be made based on information provided by the tag units 115 through transmissions 135 (e.g., ranging waveforms). These range measurements are then used by the system 100 to identify the location of the tag units 115. The range measurements continue to take place over time in order to track the whereabouts of the tag units 115 within the coverage area 110.

As illustrated by FIG. 1B, multiple tag units 115 may transmit ranging waveforms at the same time because of scheduling constraints. However, by having the ranging waveforms of the tag units 115 transmitted using distinct frequency shifts as described herein, the tag units 115 that transmit concurrently need not interfere with each other and the capacity of the system 100 may be greater than it would otherwise be if the tag units 115 conflicted with each other. A description and analysis is provided below of how the frequency shifts for use in concurrent transmissions of ranging waveforms may be determined or identified.

The typical preamble waveform (e.g., ranging waveform) transmitted by a tag unit (e.g., tag unit 115) may include M repetitions of an pseudo-random noise (PN) sequence with a period N. For a tag unit u, the time-domain PN sequence may be written as:

$${x}_{n}^{( u )} {=}^{Δ} \frac{1}{N} {\sum }_{k = - N / 2}^{N / 2 - 1} {X}_{k}^{( u )} {e}^{i \frac{2 π kn}{N}} , \qquad ( 1 )$$

where Xₖ^{(u)} may represent the complex symbols transmitted in the frequency domain and n may represent the chip index modulo N. The baseband representation of the waveform may be:

$${\tilde{x}}^{( u )} ( t ) {=}^{Δ} \frac{1}{N} {\sum }_{n} {x}_{n}^{( u )} {p}_{T} ( t - nT ) , \qquad ( 2 )$$

where T may represent the chip interval and p_{T}(t) may represent the baseband pulse. Because xₙ^{(u)} is a periodic sequence with period N, the preamble waveform \check{x}^{(u)}(t) has a period NT. The preamble waveform may be modified by introducing a frequency shift f̅ᵤ:

x^{(u)}(t)=\check{x}^{(u)}(t)e^{i2π f̅}_{^{u}}^{t}. (3)

By properly selecting the frequency shift it may be possible to orthogonalize multiple concurrent transmissions from different tag units. Because of limitations in the accuracy of frequency pre-correction, the transmitted preamble waveform may experience a small frequency error δfᵤ. Therefore, the frequency shift for the preamble waveform is fᵤ= f̅ᵤ+δfᵤ, and the preamble waveform may be expressed by:

x^{(u)}(t)=\check{x}^{(u)}(t)e^{i2πf}_{^{u}}^{t}. (4)

The maximum number of tag units L that may transmit preamble waveforms at any one time may be the total number of tag units registered in the indoor tracking system (e.g., the system 100). In this case, and based on the notion that L divides M, the tag units that transmit concurrently may be indexed as {0, . . . , L−1} and the k-th tag unit in the set may use or employ a frequency shift f̅ₖ=k/(LNT). That is, the set of distinct frequency shifts that may be used with L tag units transmitting concurrently may be expressed by:

fₖε{k/LNT:k=0,1, . . . ,L−1}. (5)

In the case where two tag units concurrently transmit preamble waveforms, for example, the distinct frequency shifts that may be assigned to the tag units are 0 and 1/(2NT).

In one example, for a PN sequence having a period N≈8192, a chip rate 1/T 1.25 GHz so that NT≈6.6 microseconds, and a preamble waveform of 20 milliseconds so that the number of PN sequence repetitions M≈3000, then the maximum tag unit frequency shift is approximately 1/NT 150 kHz. In this example, when there are 8 tag units transmitting at the same time (L=8), the distinct frequency shifts that may be assigned to the tag units are approximately 0 kHz, 18.75 kHz, 37.5 kHz, 56.25 kHz, 75 kHz, 93.75 kHz, 112.5 kHz, and 131.25 kHz. The 8 tag units may concurrently transmit during a specified time slot without interfering with each other (e.g., −55 dB of isolation) when each is assigned a different frequency shift of those listed above regardless of whether the PN sequences of the various tag units are distinct (e.g., low-correlation) or the same (e.g., high-correlation). Nevertheless, as noted above, the use of orthogonal PN sequences may be combined with the use of distinct frequency shifts in the transmission of preamble or ranging waveforms.

The tag units transmit the ranging waveforms and the APs (e.g., APs 105) may receive and process the ranging waveforms. The ranging waveforms may pass through a communication channel with an impulse response cᵤ (t) and a receiver filter p_{R}(t) at the AP. The output of the receiver filter may be provided by the following expression:

y(t)=[Σₙxₙ^{(u)}hᵤ(t−nT)]e^{i2πf}_{^{u}}^{t}, (6)

where hᵤ(t) represents an effective channel produced by cascading or combining the baseband transmit pulse p_{T}(t), the actual communication channel impulse response cᵤ (t), and the receiver filter p_{R}(t). The Fourier transform of hᵤ (t) is Hᵤ(f)=P_{R}(f+fᵤ)Cᵤ(f+fᵤ)P_{T}(f). Because fᵤ may be much smaller that 1/T, the frequency domain representation of the effective channel may be expressed by:

Hᵤ(f)≈Cᵤ(f+fᵤ)P_{R}(f)P_{T}(f). (7)

The first term in equation (6) above has a period NT, a characteristic that may be used in the analysis provided below. By sampling the output of the receiver filter at twice the chip rate (Tₛ=T/2) and stacking the samples to form a 2N-dimensional vector for sample block m, the following expression may be obtained:

yₘ [symbol] [(mNT),y(mNT+Tₛ), . . . ,y(mNT+(2N−1)Tₛ]^{T}, or

yₘ=e^{i2πf}_{^{u}}^{nMT}Φ(fᵤ)Xᵤhᵤ, (8)

where

$$Φ ( {f}_{u} ) {=}^{Δ} diag ( 1 , {e}^{i2π {f}_{u} {T}_{s}} , … , {e}^{i2π {f}_{u} ( 2 N - 1 ) {T}_{s}} ) , \\ {X}_{u} {=}^{Δ} \frac{1}{2 N} {F}^{H} {Θ}_{u} F , \\ {Θ}_{u} {=}^{Δ} diag ( {X}_{0}^{( u )} , … , {X}_{N - 1}^{( u )} , {X}_{0}^{( u )} , … , {X}_{N - 1}^{( u )} ) , \\ {[ F ]}_{n , k} {=}^{Δ} {e}^{- i \frac{2 π nk}{2 N}} , for 0 \leq n , k \leq 2 N - 1 , and \\ {h}_{u} {=}^{Δ} {( {h}_{u} ( 0 ) , {h}_{u} ( {T}_{s} ) , … , {h}_{u} ( ( 2 N - 1 ) {T}_{s} ) )}^{T} . \qquad ( 9 )$$

The above expressions may result when N is large enough that the length of hᵤ(t) is less than NT, and may indicate that Xᵤ, is a circulant matrix whose first column consists of the sequence {xₙ^{(u)}} upsampled by 2. The analysis provided above is directed at a single tag unit transmission. A generalization to concurrent transmissions of preamble or ranging waveforms by multiple tag units may be expressed as:

yₘ=Σᵤe^{i2πf}_{^{u}}^{nMT}Φ(fᵤ)Xᵤhᵤ, (10)

To compute the v-th tag's channel estimate, the receiver at the AP may rotate each m-block and may produce the following result:

$$Y ( v ) = \frac{1}{M} {\sum }_{m = 0}^{M - 1} {e}^{- i2π {\hat{f}}_{v} mNT} {y}_{m} , \qquad ( 11 )$$

where \hat{f} is the estimated frequency offset of the v-th tag. The channel estimate ĥᵥ is then obtained as:

ĥᵥ [symbol] (Xᵥ^{H}Xᵥ)⁻¹Xᵥ^{H}Φ(\hat{f}ᵥ)⁻¹Y(v). (12)

The v-th tag vector Y(v) may be further expanded as follows:

$$\begin{matrix}Y ( v ) = \frac{1}{M} {\sum }_{m = 0}^{M - 1} {e}^{- i2π {\hat{f}}_{v} mNT} {y}_{m} , \\ Y ( v ) = \frac{1}{M} {\sum }_{u} [ {\sum }_{m = 0}^{M - 1} {e}^{i2π mNT ( {f}_{u} - {\hat{f}}_{v} )} ] Φ ( {f}_{u} ) {X}_{u}^{H} {h}_{u} , \\ Y ( v ) = {\sum }_{u} β ( M , NT ( {f}_{u} - {\hat{f}}_{v} ) ) Φ ( {f}_{u} ) {X}_{u}^{H} {h}_{u} , \\ Y ( v ) = β ( M , NT ( {f}_{u} - {\hat{f}}_{v} ) ) Φ ( {f}_{u} ) {X}_{u}^{H} {h}_{u} + Interference \\ where & ( 13 ) \\ β ( M , θ ) {=}^{Δ} {e}^{iπ ( M - 1 ) θ} ( \frac{1}{M} ) \frac{sin M πθ}{sin πθ} , \\ and & ( 14 ) \\ Interference {=}^{Δ} {\sum }_{u \neq v} β ( M , NT ( {f}_{u} - {\hat{f}}_{v} ) ) Φ ( {f}_{u} ) {X}_{u}^{H} {h}_{u} . & ( 15 )\end{matrix}$$

The interference described above may represent the terms in the summation that result in cross-talk from the concurrent transmissions of ranging waveforms from multiple tag units.

The receiver at the AP for the v-th tag may select \hat{f}ᵥ≈ f̅ᵥ, possibly with Doppler bins to account for the frequency error of the tag unit. In such a case, β(M,NT(fᵥ−\hat{f}ᵥ)≈1 and the v-th vector Y(v) may become:

Y(v)≈Φ(fᵥ)Xᵥ^{H}hᵥ+Interference, (16)

and the channel estimate may be rewritten as:

ĥᵥ [symbol] hᵥ+(Xᵥ^{H}Xᵥ₎⁻¹Xᵥ^{H}Φ(\hat{f}ᵥ)⁻¹[Interference]. (17)

The interference term may be made small by properly selecting the value of f̅ᵤ. For example, the interference term may be rewritten as:

Interference=Σ_{u≠v}β(M,NT([ f̅ᵤ− f̅ᵥ]+[δfᵤ−δfᵥ]))Φ(fᵤ)Xᵤ^{H}hᵤ. (18)

If δfᵤ and δfᵥ are sufficiently small that may be considered close to negligible (i.e., in the absence of frequency errors), the interference term may be removed when β(M,NT[ f̅ᵤ− f̅ᵥ])=0, which occurs when:

$${\overline{f}}_{u} - {\overline{f}}_{v} = \frac{k}{MNT} , k \neq 0. \qquad ( 19 )$$

In the presence of frequency errors, it may be possible to obtain a simple bound for the cross-talk interference. Since there are L tag units that may be concurrently transmitting ranging waveforms, and based on the notion that L divides M, the tag units may transmit ranging waveforms at the following frequencies {k/LNT:k=0, 1, . . . , L−1}. By shifting the frequencies of the L tag units in such a manner, it ensures that:

$$\vert {\overline{f}}_{u} - {\overline{f}}_{v} \vert \geq \frac{1}{LNT} , u \neq v . \qquad ( 20 )$$

In the event that

$$\vert δ {f}_{u} - δ {f}_{v} \vert < \frac{1}{2 LNT} ,$$

which may be easily satisfied since the frequency errors are expected to be only a few kilohertz at most and from the example shown above 1/LNT is approximately 19 kHz, then we have:

$$\vert [ {\overline{f}}_{u} - {\overline{f}}_{v} ] + [ δ {f}_{u} - δ {f}_{v} ] \vert \geq \frac{1}{2 LNT} , \qquad ( 21 )$$

and therefore,

$$\vert β ( M , NT ( [ {\overline{f}}_{u} - {\overline{f}}_{v} ] + [ δ {f}_{u} - δ {f}_{v} ] ) ) \vert \leq {max}_{θ \geq 1 / ( 2 LNT )} \vert β ( M , NT θ ) \vert \\ \vert β ( M , NT ( [ {\overline{f}}_{u} - {\overline{f}}_{v} ] + [ δ {f}_{u} - δ {f}_{v} ] ) ) \vert \leq {max}_{x \geq 1 / ( 2 L )} \vert β ( M , x ) \vert \\ \vert β ( M , NT ( [ {\overline{f}}_{u} - {\overline{f}}_{v} ] + [ δ {f}_{u} - δ {f}_{v} ] ) ) \vert \leq \frac{1}{M} ( {max}_{x \geq 1 / ( 2 L )} 1 / sin π x ) \\ \vert β ( M , NT ( [ {\overline{f}}_{u} - {\overline{f}}_{v} ] + [ δ {f}_{u} - δ {f}_{v} ] ) ) \vert \leq {( M sin \frac{ π}{2 L} )}^{- 1} . \qquad ( 22 )$$

The relative strength of each of the interference terms to a desired user term is then [M sin π/(2 L)]⁻¹. Returning to the example described above, when the PN sequence has a period N≈8192, the chip rate is 1/T≈1.25 GHz so that NT≈6.6 microseconds, the preamble waveform is 20 milliseconds so that the number of PN sequence repetitions M≈3000, and L=8, the relative strength of the interference term to the desired user term is approximately −55 dB. When L=2, the isolation that may be achieved between two tag units transmitting concurrently is approximately −67 dB.

The above analysis and description illustrates that even when tag unit frequency errors are taken into account, over 55 dB of cross-talk isolation may be achieved when 8 tag units transmit preamble or ranging waveforms concurrently by assigning an appropriate and distinct frequency shift to each of the tag units for transmitting the ranging waveforms. Below are provided additional details of various components of an indoor tracking system (e.g., the system 100) in which distinct frequency shifts are assigned to the tag units to improve the isolation between those tag units when concurrently transmitting ranging waveforms.

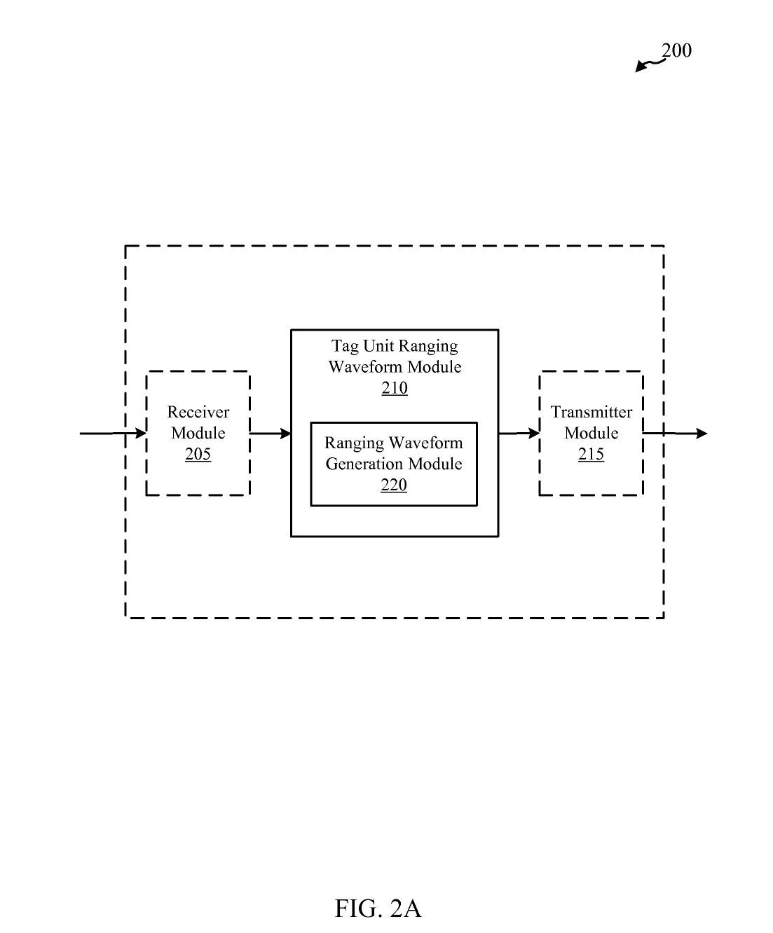

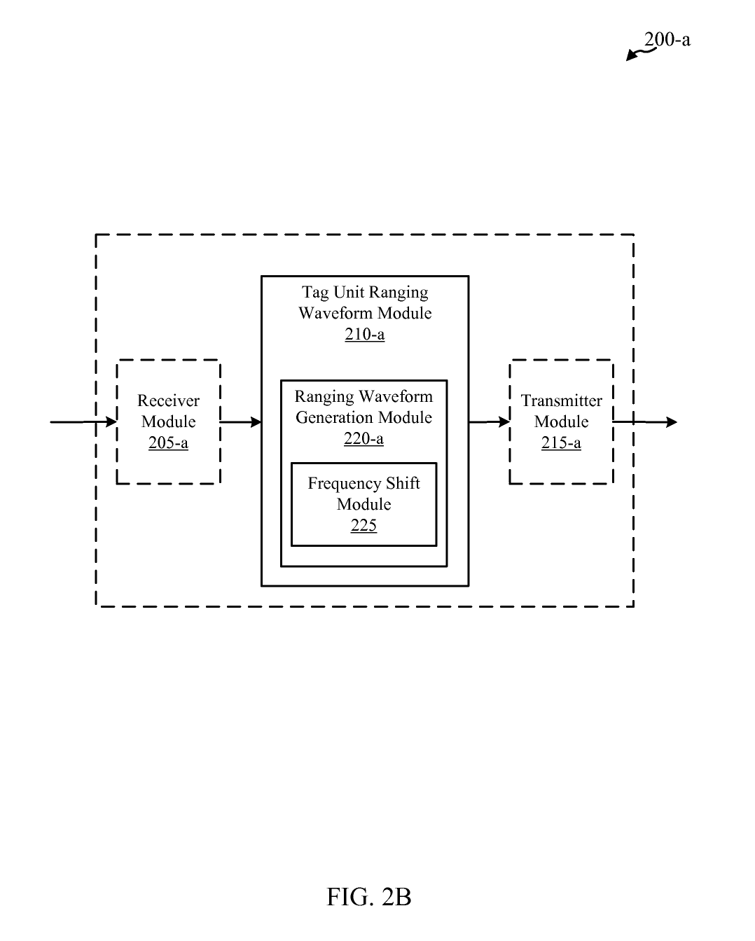

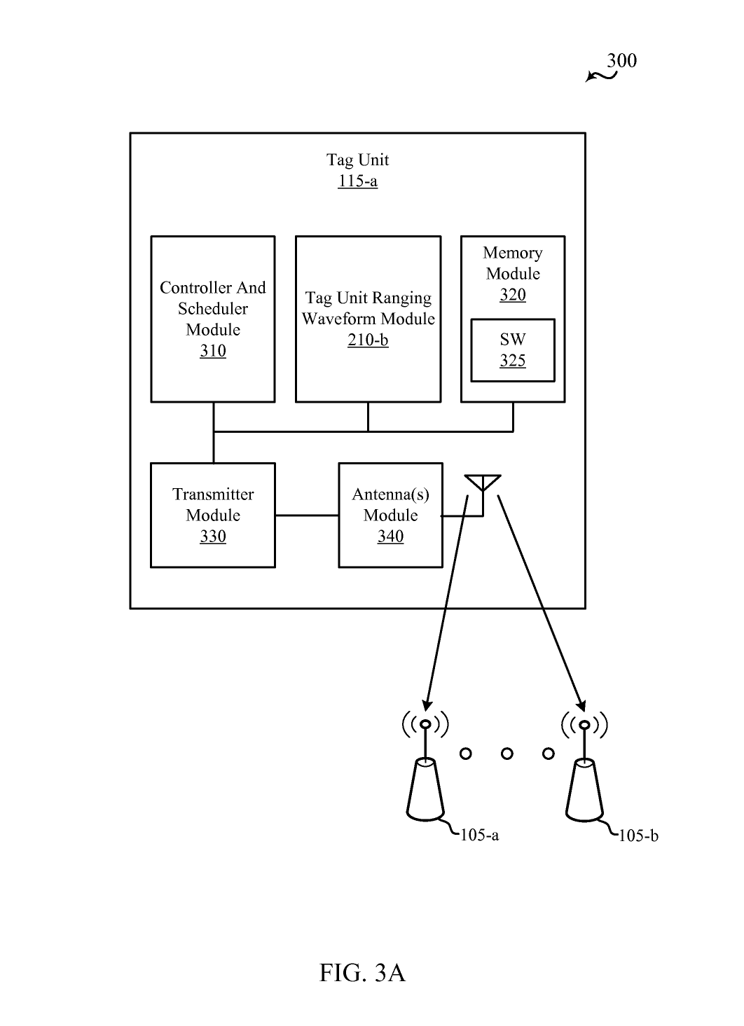

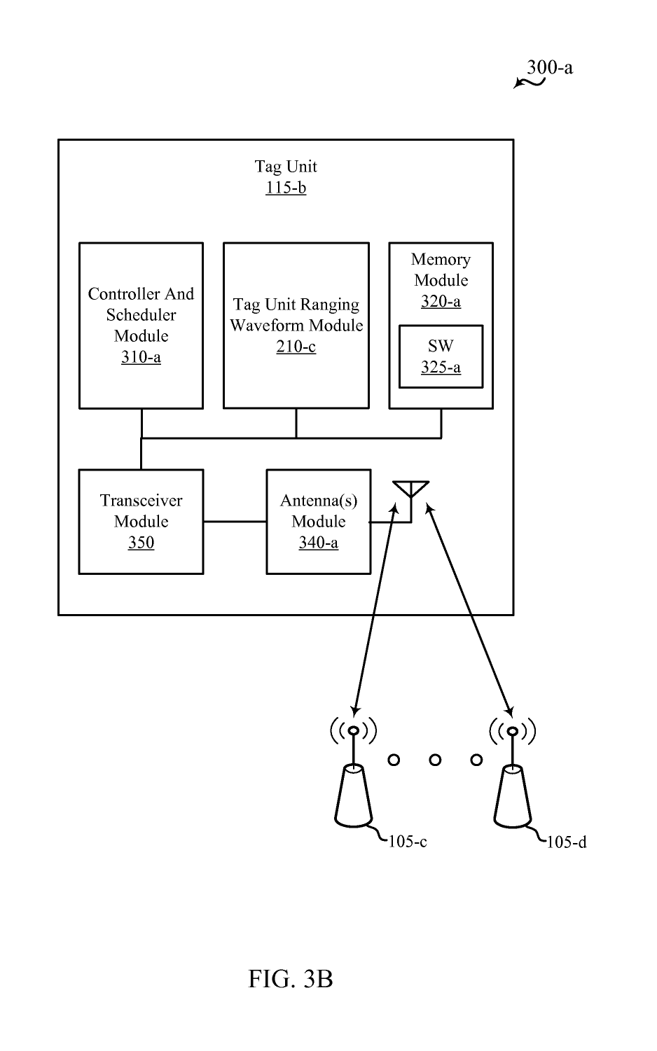

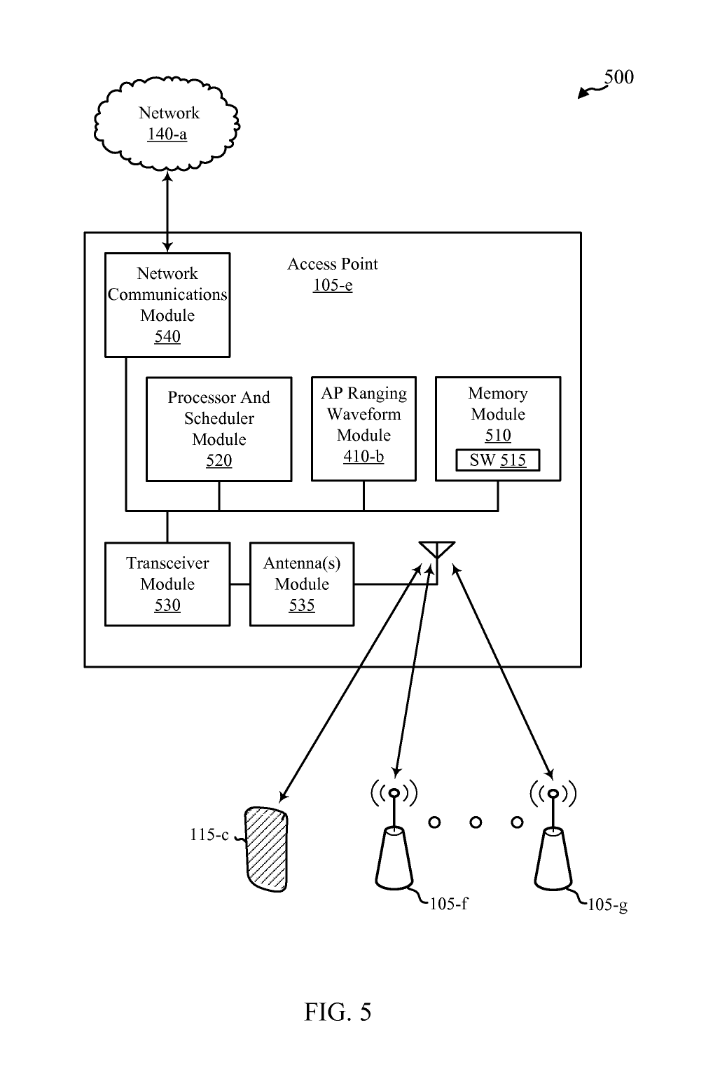

Turning next to FIG. 2A, a block diagram illustrates a device 200 configured for using distinct frequency shifts in ranging waveforms in accordance with various embodiments. The device 200 may be an example of one or more aspects of the tag units 115 described with reference to FIG. 1A, FIG. 1B, FIG. 3A, FIG. 3B, and FIG. 5. The device 200 may also be a processor. The device 200 may include a receiver module 205, a tag unit ranging waveform module 210, and/or a transmitter module 215. The tag unit ranging waveform module 210 may include a ranging waveform generation module 220. Each of these components may be in communication with each other.

The device 200, through the receiver module 205, the ranging waveform generation module 220 in the tag unit ranging waveform module 210, and/or the transmitter module 215, may be configured to receive an assignment for a tag or tag unit (e.g., tag unit 115), where the assignment includes a frequency shift for transmission of ranging waveforms to one or more access points (e.g., APs 105), and where the frequency shift is distinct for each tag unit in a set that also includes the tag unit (e.g., tag units 115 in FIG. 1A or FIG. 1B). In some embodiments, the assignment may include a particular PN sequence and/or a particular time slot for the transmission of the ranging waveforms. The device 200 may be configured to generate the ranging waveforms with the frequency shift and transmit the ranging waveforms using the frequency shift. The device 200 may be configured to transmit one or more UWB signals that include the ranging waveforms.

In some embodiments, the device 200 is configured to receive a new assignment for the tag unit, where the new assignment includes a new frequency shift for transmission of the ranging waveforms that is distinct from a new frequency shift for each tag unit in the set. The new frequency shift may be received in response to a change in the number of tag units in the set. For example, as described above with reference to FIG. 1A and FIG. 1B, the number of tag units may increase or decrease according to the number of assets or persons being tracked and the tracking management server 150 may assign new frequency shifts to the tag units, or in this case to the device 200, to use for generating and transmitting ranging waveforms.

FIG. 2B shows a block diagram of a device 200-a configured for using distinct frequency shifts in ranging waveforms in accordance with various embodiments. The device 200-a may be an example of the device 200 of FIG. 2A and may perform the same or similar functions as those described above for the device 200. Moreover, the device 200-a may be an example of one or more aspects of the tag units 115 described with reference to FIG. 1A, FIG. 1B, FIG. 3A, FIG. 3B, and FIG. 5. The device 200-a may also be a processor. The device 200-a may include a receiver module 205-a, a tag unit ranging waveform module 210-a, and/or a transmitter module 215-a, which may be examples of their corresponding modules in FIG. 2A. The tag unit ranging waveform module 210-a may include a ranging waveform generation module 220-a, which may be an example of the corresponding module in FIG. 2A. The ranging waveform generation module 220-a may include a frequency shift module 225. Each of these components may be in communication with each other.

The frequency shift module 225 may be configured handle various aspects described herein related to receiving, processing, storing, replacing, and using frequency shifts assigned for use with a particular tag unit (e.g., tag unit 115) in an indoor tracking system (e.g., the system 100) to concurrently transmit ranging waveforms without interfering with the transmissions of other tag units.

Turning next to FIG. 3A, there is shown a diagram 300 illustrating a tag unit 115-a that may be an example of the tag units 115 of FIG. 1A, FIG. 1B, and FIG. 5. The tag unit 115-a may include a controller and scheduler module 310, a memory module 320, a transmitter module 330, and antenna(s) module 340. The tag unit 115-a may also include a tag unit ranging waveform module 210-b that may be an example of the tag unit ranging waveform modules 210 and 210-a of FIG. 2A and FIG. 2B, respectively. Although not shown in FIG. 3A, the tag unit 115-a may also include a battery that enables the tag unit 115-a to be used as a battery-operated device. Each of these components may be in communication, directly or indirectly.

The controller and scheduler module 310 may produce a clock and/or some other timing signal that is used by the tag unit 115-a to generate ranging waveforms (e.g., preamble waveforms or preamble signals) for broadcasting. For example, the clock and/or timing signal may be used to broadcast the ranging waveforms at an appropriate time slot. The timing of the generation of ranging waveforms may be based, at least in part, on transmission time slots assigned to the tag unit 115-a by a network entity in the indoor tracking system (e.g., the tracking management server 150). In some embodiments, the controller and scheduler module 310 may include an oscillator and/or a frequency synthesizer that produces the appropriate clock for the operation of the tag unit 115-a.

The controller and scheduler module 310 may also include logic and/or code that enables it to control the operations of the tag unit 115-a. For example, the controller and scheduler module 310 may include a microcontroller or a state machine to control the generation of ranging waveforms using distinct frequency shifts and the periodic transmission of the ranging waveforms. The ranging waveforms typically include information that identifies the tag unit 115-a and distinguishes it from other tag units. Information used by the controller and scheduler module 310 to control the generation of the ranging waveforms may have been obtained as part of an assignment provided by the indoor tracking system for the tag unit 115-a.

The memory module 3230 may include random access memory (RAM) and/or read-only memory (ROM). The memory module 320 may also store computer-readable, computer-executable software (SW) code 325 containing instructions that are configured to, when executed, cause the controller and scheduler module 310 to perform various functions described herein for controlling the generation and transmission of ranging waveforms. Alternatively, the software code 325 may not be directly executable by the controller and scheduler module 310 but be configured to cause the computer, e.g., when compiled and executed, to perform functions described herein.

The tag unit ranging waveform module 210-b may perform, alone or in coordination with the controller and scheduler module 310, some or all of the functions described above with reference to the tag unit ranging waveform modules 210 and 210-a of FIG. 2A and FIG. 2B, respectively.

The transmitter module 330 may support a radio frequency (RF) communication technology (e.g., UWB) to broadcast ranging waveforms through the antenna(s) module 340. For example, the transmitter module 330 may include a modulator (not shown) to modulate ranging information and provide the modulated ranging information to the antenna(s) module 340 for transmission as ranging waveforms or ranging signals. As shown in FIG. 3A, the broadcast of ranging waveforms from the tag unit 115-a may be received by one or more APs 105. In this example, the tag unit 115-a is shown to broadcast ranging waveforms to APs 105-a through 105-b.

Because the tag unit 115-a does not have signal reception capabilities, the tag unit 115-a may reduce power consumption, and may prolong the life of the battery, by going into a sleep mode when not broadcasting ranging waveforms.

FIG. 3B shows a tag unit 115-b that may be an example of the tag units 115 of FIG. 1A, FIG. 1B, and FIG. 5. The tag unit 115-b may include a controller and scheduler module 310-a, a memory module 320-a, a transceiver module 350, and antenna(s) module 340-a. The tag unit 115-b may also include a tag unit ranging waveform module 210-c that may be an example of the tag unit ranging waveform modules 210 and 210-a of FIG. 2A and FIG. 2B, respectively. The controller and scheduler module 310-a, the memory module 320-a, and the tag unit ranging waveform module 210-c may be examples of the corresponding modules described above with respect to FIG. 3A and their description may be omitted for brevity. Like the tag unit 115-a in FIG. 3A, the tag unit 115-b may also include a battery that enables the tag unit 115-b to be used as a battery-operated device. Each of these components may be in communication, directly or indirectly.

The transceiver module 350 may support RF communication technology (e.g., UWB) to broadcast ranging waveforms through the antenna(s) module 340-a and to receive signals through the antenna(s) module 340-a. For example, the transceiver module 350 may include a modulator (not shown) to modulate ranging information and provide the modulated ranging information to the antenna(s) module 340-a for transmission as ranging waveforms or ranging signals. The transceiver module 350 may also include a demodulator to demodulate signals received through the antenna(s) module 340-a that may include, for example, assignment information to enable the assignment of new frequency shifts to the tag unit 115-b when the number of tags in the indoor tracking system changes. As shown in FIG. 3B, the broadcast of ranging waveforms from the tag unit 115-b may be received by one or more APs 105. In this example, the tag unit 115-b is shown to broadcast ranging waveforms to APs 105-c through 105-d. Moreover, the tag unit 115-b may receive ranging waveforms assignment information (e.g., a new frequency shift, a new time slot, and/or a new PN sequence) from one or more APs 105.

Because the tag unit 115-b enables some form of bi-directional communication with one or more APs 105, the tag unit 115-b may go into a sleep mode when not broadcasting ranging waveforms but may also be configured to wake up at certain times to receive any new ranging waveforms assignments. In one example, the new assignments for an indoor tracking system may occur at specified times of the day and the tag unit 115-b need only wake up to check for new assignments at those times.

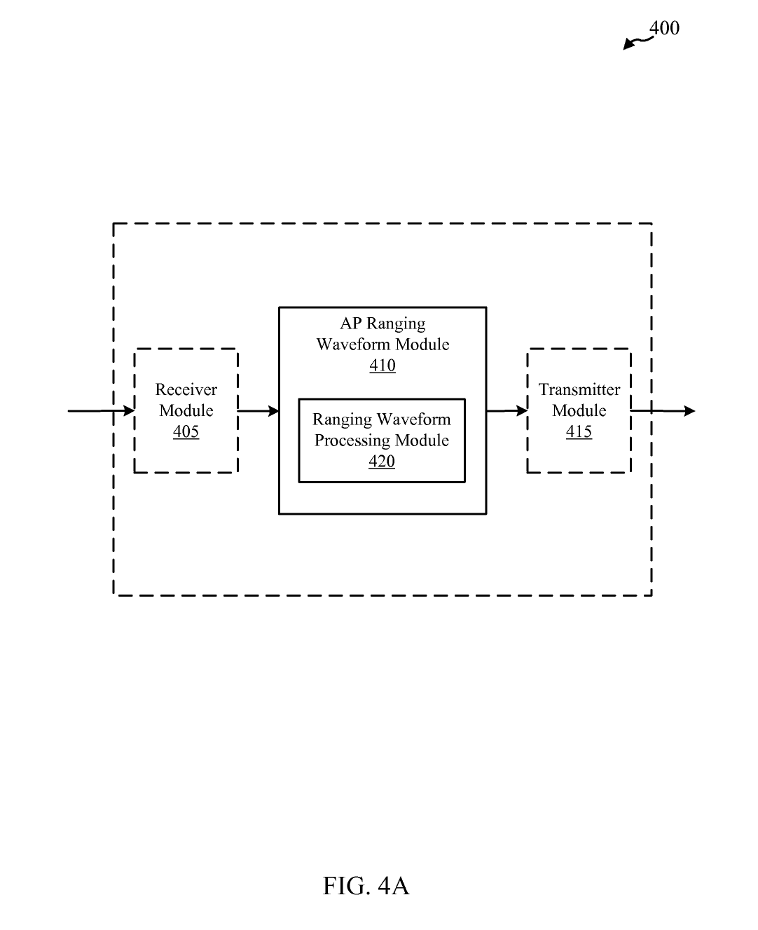

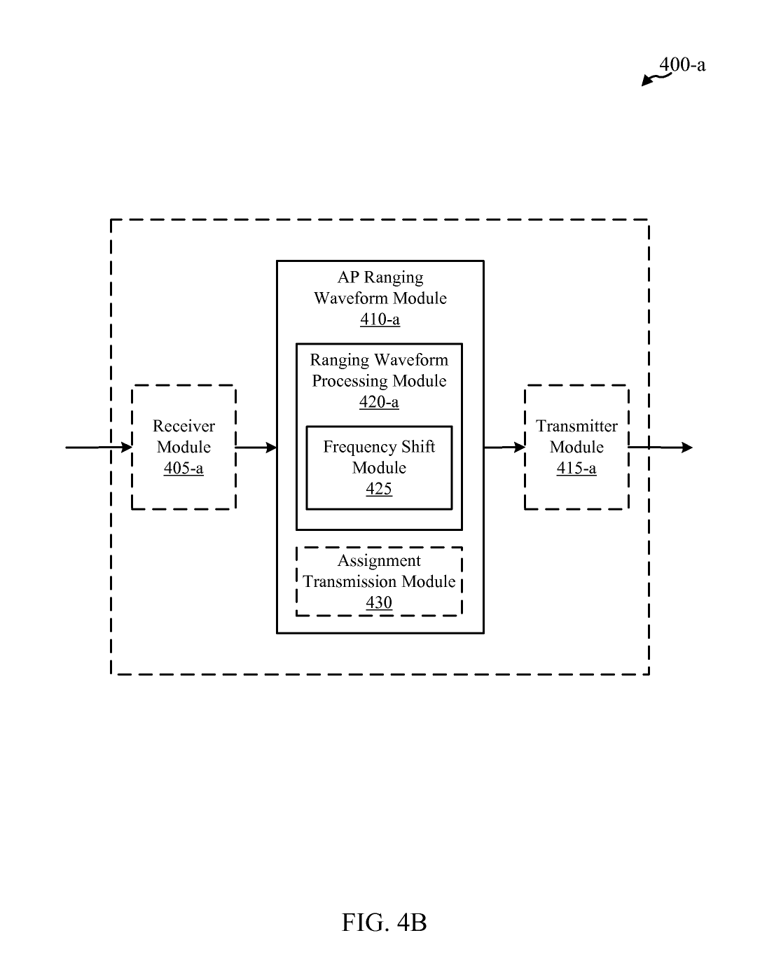

Turning next to FIG. 4A, a block diagram illustrates a device 400 configured for using distinct frequency shifts in ranging waveforms in accordance with various embodiments. The device 400 may be an example of one or more aspects of the APs 105 described with reference to FIG. 1A, FIG. 1B, FIG. 3A, FIG. 3B, and FIG. 5. The device 400 may also be a processor. The device 400 may include a receiver module 405, an AP ranging waveform module 410, and/or a transmitter module 415. The AP ranging waveform module 410 may include a ranging waveform processing module 420. Each of these components may be in communication with each other.

The device 400, through the receiver module 405, the ranging waveform processing module 420 in the AP ranging waveform module 410, and/or the transmitter module 415, may be configured to receive ranging waveforms from one or more tag units (e.g., tag units 115) in a set of tag units (e.g., tag units 115 in FIG. 1A or FIG. 1B), where the ranging waveforms are transmitted by the one or more tag units using assigned distinct frequency shifts. The device 400 may be configured to receive one or more UWB signals that include the ranging waveforms. The device 400 may be configured to identify an earliest path corresponding to one of the tag units based on the ranging waveforms received from that one tag unit and determine a ranging measurement corresponding to the one tag unit based at least in part on the identified earliest path. The device 400 may be configured to communicate information about the ranging waveforms and/or the ranging measurement to a network entity (e.g., the tracking management server 150) for further processing. The processing may include the determination of a location estimate for the one tag unit based at least in part on the ranging measurement.

FIG. 4B shows a block diagram illustrates a device 400-a configured for using distinct frequency shifts in ranging waveforms in accordance with various embodiments. The device 400-a may be an example of the device 400 of FIG. 4A and may perform the same or similar functions as those described above for the device 400. Moreover, the device 400-a may be an example of one or more aspects of the APs 105 described with reference to FIG. 1A, FIG. 1B, FIG. 3A, FIG. 3B, and FIG. 5. The device 400-a may also be a processor. The device 400-a may include a receiver module 405-a, an AP ranging waveform module 410-a, and/or a transmitter module 415-a, which may be examples of their corresponding modules in FIG. 4A. The AP ranging waveform module 410-a may include a ranging waveform processing module 420-a, which may be an example of the corresponding module in FIG. 4A. The ranging waveform processing module 420-a may include a frequency shift module 425. Moreover, the AP ranging waveform module 410-a may also include an assignment transmission module 430. Each of these components may be in communication with each other.

The frequency shift module 425 may be configured to handle various aspects described herein related to receiving and processing ranging waveforms that are transmitted by tag units (e.g., tag units 115) using frequency shifts assigned by an indoor tracking system to enable concurrent transmissions of ranging waveforms without interference.

The assignment transmission module 430 may be configured to receive assignment information from a server (e.g., the tracking management server 150) and convey the assignment information to one or more tag units. The assignment information may include one or more of a new or updated frequency shift to be used for transmitting ranging waveforms, a new or updated PN sequence for use in transmitting ranging waveforms, and a new or update schedule of time slots for transmitting ranging waveforms. The assignment transmission module 430 may be used when a dynamic update of tag units assignment is supported by the indoor tracking system through wireless communication between the tag units and the APs. Such an approach, however, may be limited to those tag units that are configured for receiving and updating their ranging waveform assignments after being registered and deployed in the coverage area (e.g., the coverage area 110).

Turning to FIG. 5, an AP 105-e is shown that may be an example of the APs 105 of FIG. 1A, FIG. 1B, FIG. 3A, and FIG. 3B. The AP 105-e may include a memory module 510, a processor and scheduler module 520, a transceiver module 530, antenna(s) module 535, a network communications module 540, and an AP ranging waveform module 410-b. The AP ranging waveform module 410-b may be an example of the AP ranging waveform modules 410 and 410-a of FIG. 4A and FIG. 4B, respectively. Each of these components may be in communication, directly or indirectly.

The processor and scheduler module 520 may produce a clock and/or some other timing signal that is used by the AP 105-e during operations. In some embodiments, the processor and scheduler module 520 may include an oscillator and/or a frequency synthesizer that produces the appropriate clock for the operation of the AP 105-e. The clock used by the AP 105-e may be offset from the clock used by other APs and/or from the clock used by a tag unit (e.g., tag unit 115). To compensate for the clock offset, particularly during range measurements used to determine the location of a tag unit, the AP 105-e may send and/or receive information (e.g., ranging waveforms) from other APs to determine the clock offset between the AP 105-e and those other APs.

The memory module 510 may include random access memory (RAM) and read-only memory (ROM). The memory module 510 may also store computer-readable, computer-executable software (SW) code 515 containing instructions that are configured to, when executed, cause the processor and scheduler module 520 to perform various functions described herein related to the synchronization with other APs, the reception and processing of ranging waveforms, and, in some embodiments, the reception and subsequent conveyance of assignment information to tag units for the transmission of ranging waveforms. Alternatively, the software code 515 may not be directly executable by the processor and scheduler module 520 but be configured to cause the computer, e.g., when compiled and executed, to perform functions described herein.

The processor and scheduler module 520 may include an intelligent hardware device, e.g., a central processing unit (CPU) such as those made by Intel® Corporation or AMD®, a microcontroller, an application-specific integrated circuit (ASIC), etc. The processor and scheduler module 520 may perform various operations associated with synchronizing the AP 105-e to other APs. For example, the processor and scheduler module 520 may be used to generate data and prepare that data for transmission to another AP to determine a clock offset between the AP 105-e and the other AP. The processor and scheduler module 520 may use scheduling information received from, for example, the tracking management server 150, to determine which signals to generate and when to transmit the signals for determining a clock offset between the AP 105-e and another AP. The processor and scheduler module 520 may perform various operations associated with the reception and processing of ranging waveforms, and, in some embodiments, the reception and subsequent conveyance of assignment information to tag units for the transmission of ranging waveforms

The transceiver module 530 may include a modem configured to modulate the data (e.g., packets) and provide the modulated data to the antenna(s) module 535 for transmission, and to demodulate data received from the antenna(s) module 535. While some examples of the AP 105-e may include a single antenna, the AP 105-e may include multiple antennas. As shown in FIG. 5, broadcast ranging waveforms (e.g., preamble waveforms or signals) transmitted from a tag unit 115-c may be received by the AP 105-e through the antenna(s) in the antenna(s) module 535. In some embodiments, the AP 105-e may convey information (e.g., assignment information) to the tag unit 115-c through the antenna(s) module 535. Moreover, the AP 105-e may wirelessly communicate with other APs such as APs 105-f through 105-g, for example. In some cases, the AP 105-e may communicate with a network 140-a through the network communications module 540. The network 140-a may be an example of the network 140 of FIG. 1A and FIG. 1B.

The AP ranging waveform module 410-b may perform, alone or in coordination with the processor and scheduler module 520, some or all of the functions described above with reference to the AP ranging waveform modules 410 and 410-a of FIG. 4A and FIG. 4B, respectively.

In some embodiments, the transceiver module 530 and/or the antenna(s) module 535 may support multiple RF communications technologies. One of the technologies supported may be UWB communications. UWB communications may be used to transmit/receive certain type of information between APs for clock offset determination and system synchronization. UWB communications may be used to receive ranging waveforms from tag units. Moreover, when supported by the AP 105-e and at least some tag units, UWB communications may be used to transmit assignment information to the tag units.

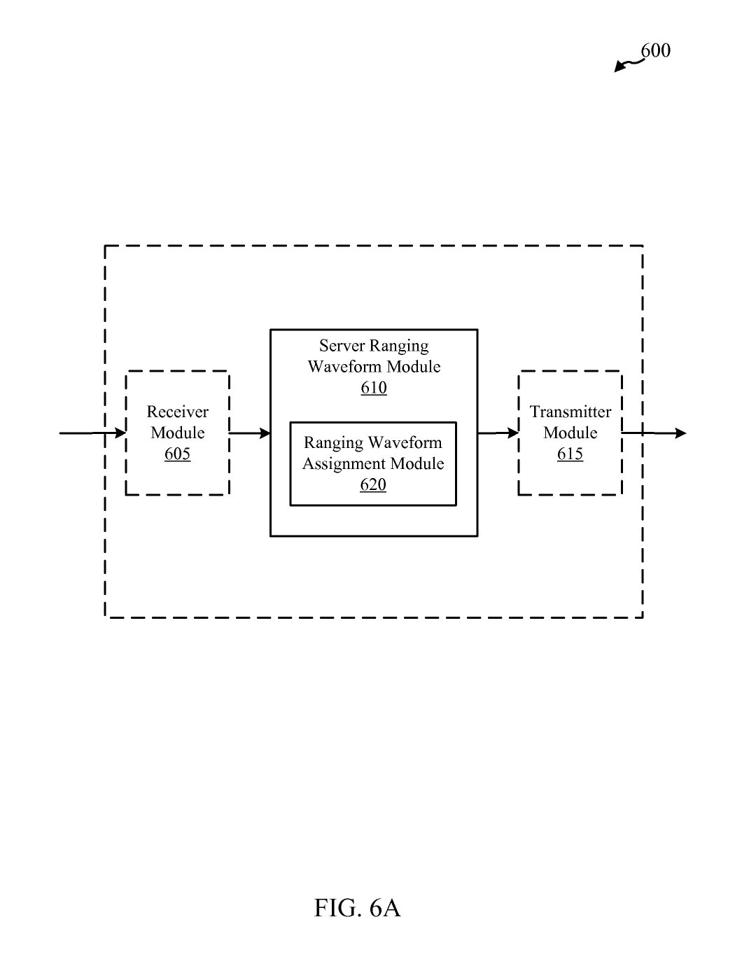

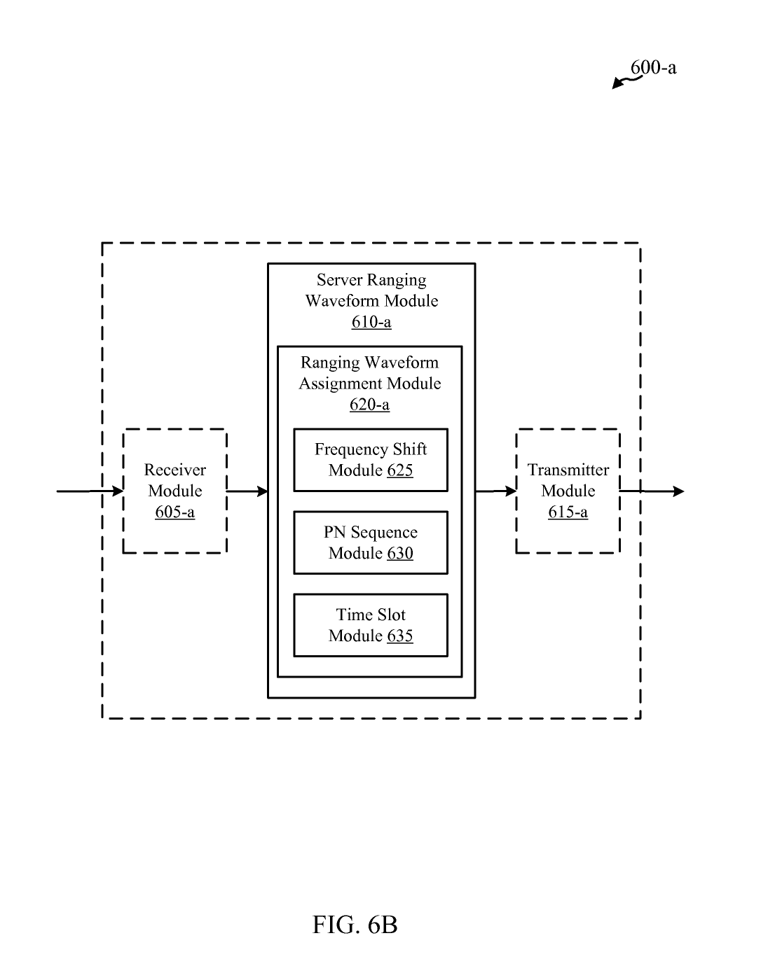

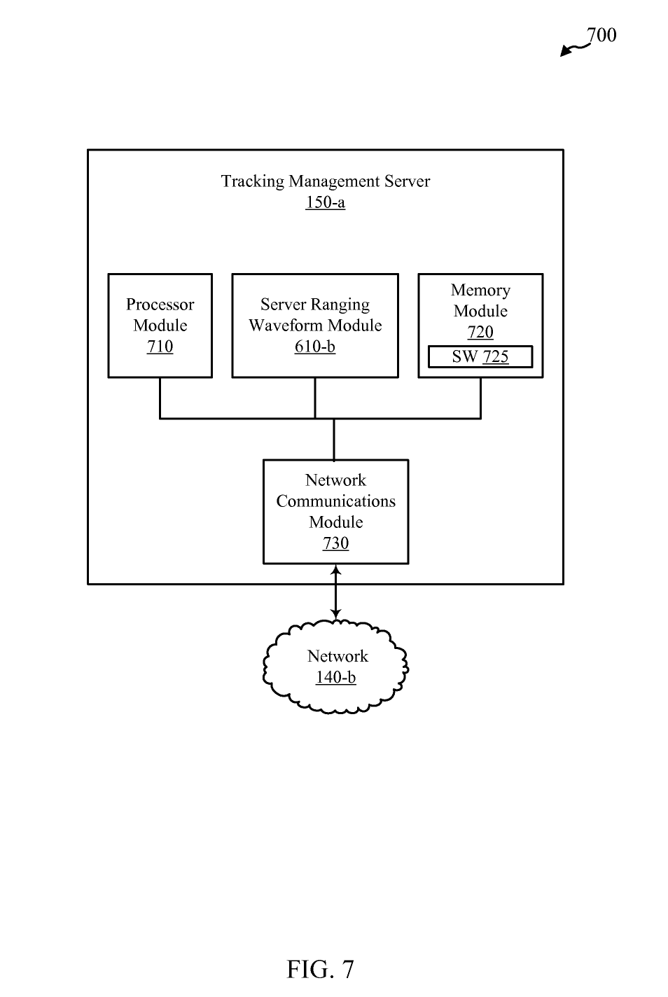

Turning next to FIG. 6A, a block diagram illustrates a device 600 configured for using distinct frequency shifts in ranging waveforms in accordance with various embodiments. The device 600 may be an example of one or more aspects of the tracking management servers 150 described with reference to FIG. 1A, FIG. 1B, and FIG. 7. The device 600 may also be a processor. The device 600 may include a receiver module 605, a server ranging waveform module 610, and/or a transmitter module 615. The server ranging waveform module 610 may include a ranging waveform assignment module 620. Each of these components may be in communication with each other.

The device 600, through the receiver module 605, the ranging waveform assignment module 620 in the server ranging waveform module 610, and/or the transmitter module 615, may be configured to assign to each tag unit in a set of tag units (e.g., the tag units 115 in FIG. 1A and FIG. 1B) a distinct frequency shift associated with ranging waveforms, where each of the tag units in the set is attached to a different asset or person being tracked. The device 600 may determine a location estimate for the tag units based at least in part on ranging waveforms transmitted by the tag units. The ranging waveforms may be received and processed by one or more APs (e.g., APs 105), and the processed information may be provided to the device 600 to determine the location estimates. In some instances, the APs may pass information associated with the ranging waveforms to the device 600 for full processing.

The device 600 may be configured to assign a distinct frequency shift to each of the tag units in the set based at least in part on a total number of tag units in the set. The device 600 may be configured to assign a specified time slot(s) for the tag units in the set to concurrently transmit ranging waveforms using the distinct frequency shifts. Moreover, the device 600 may be configured to assign to each of the tag units in the set a PN sequence for use in the ranging waveforms. The PN sequence assigned to one tag unit may be different from the PN sequence assigned to another tag unit. The frequency shifts may be based at least in part on N, which is the period of the PN sequence. That is, xₙ^{(u)} in equation (1) may repeat every N symbols. The PN sequence assigned may be from a set of low-correlation PN sequences or may be from a set that includes PN sequences with a higher degree of correlation.

The device 600 may be configured to assign the set of tag units to a first specified time slot and to assign a different set of tag units to a second specified time slot different from the first specified time slot. The device 600 may be configured to receive ranging measurements from APs (e.g., APs 106) and determine location estimates for one or more tag units from those measurements.

The device 600 may be configured to register tag units and assign frequency shifts, PN sequences, and/or time slots to the tag units during the registration process. The device 600 may be configured to identify a change in the number of tag units and to assign to each tag unit in the updated or modified set a new distinct frequency shift associated with the ranging waveforms, where each new distinct frequency shift is based at least in part on the identified change in the number of tags.

FIG. 6B shows a block diagram illustrates a device 600-a configured for using distinct frequency shifts in ranging waveforms in accordance with various embodiments. The device 600-a may be an example of the device 600 of FIG. 6A and may perform the same or similar functions as those described above for the device 600. Moreover, the device 600-a may be an example of one or more aspects of the tracking management servers 150 described with reference to FIG. 1A, FIG. 1B, and FIG. 7. The device 600-a may also be a processor. The device 600-a may include a receiver module 605-a, a server ranging waveform module 610-a, and/or a transmitter module 615-a, which may be examples of their corresponding modules in FIG. 6A. The server ranging waveform module 610-a may include a ranging waveform assignment module 620-a, which may be an example of the corresponding module in FIG. 6A. The ranging waveform assignment module 620-a may include a frequency shift module 625, a PN sequence module 630, and a time slot module 635. Each of these components may be in communication with each other.

The frequency shift module 625 may be configured to handle various aspects described herein related to generating, identifying, assigning, and updating distinct frequency shifts for tag units (e.g., tag units 115) to use when concurrently transmitting ranging waveforms.

The PN sequence module 630 may be configured to handle various aspects described herein related to generating, identifying, assigning, and updating PN sequences for tag units (e.g., tag units 115) to use when concurrently transmitting ranging waveforms.

The time slot module 635 may be configured to handle various aspects described herein related to identifying, assigning, and updating time slot(s) for tag units (e.g., tag units 115) to use when concurrently transmitting ranging waveforms.

Turning to FIG. 7, a tracking management server 150-a is shown that may be an example of the tracking management server 150 of FIG. 1A and FIG. 1B. The tracking management server 150-a may include a processor module 710, a memory module 720, a network communications module 730, and a server ranging waveform module 610-b. The server ranging waveform module 610-b may be an example of the server ranging waveform modules 610 and 610-a of FIG. 6A and FIG. 6B, respectively. Each of these components may be in communication, directly or indirectly.

The processor module 710 may include an intelligent hardware device, e.g., a CPU such as those made by Intel® Corporation or AMD®, a microcontroller, an ASIC, etc. The processor module 710 may perform various operations associated with synchronizing APs (e.g., APs 105). For example, the processor module 710 may be used to schedule the transmission of data from one or more APs to one or more other APs to determine clock offsets. The processor module 710 may process information from one or more APs. For example, the processor module 710 may process information for range measurements, distance calculations, and clock offset determination. In some cases, the tracking management server 150-a may communicate with a network 140-b through the network communications module 730 to receive information from the APs and/or to send information to the APS. The network 140-b may be an example of the networks 140 and 140-a of FIG. 1A, FIG. 1B, and FIG. 5.

The processor module 710 may also perform various operations associated with assigning frequency shifts to tag units (e.g., tag units 115) to use for concurrent transmissions of ranging waveforms. For example, the processor module 710 may be used to determine or identify distinct frequency shifts and assign the frequency shifts to the tag units. The processor module 710 may also be used to determine or identify PN sequences and/or time slot(s) to assign to the tag units. The processor module 710 may also be used to register the tag units and determine when the number of tag units in the indoor tracking system (e.g., the system 100) has changed. When the number of tag units changes as more or fewer assets or persons are tracked, the processor module 710 may be used to determine or identify new distinct frequency shifts, PN sequences, and/or time slot(s) to assign to the current set of tag units in the system.

The memory module 720 may include RAM and ROM. The memory module 720 may also store computer-readable, computer-executable software code 725 containing instructions that are configured to, when executed, cause the processor module 725 to perform various functions described herein. Alternatively, the software code 725 may not be directly executable by the processor module 710 but be configured to cause the computer, e.g., when compiled and executed, to perform functions described herein.

The server ranging waveform module 610-b may perform, alone or in coordination with the processor module 710, some or all of the functions described above with reference to the server ranging waveform modules 610 and 610-a of FIG. 6A and FIG. 6B, respectively.

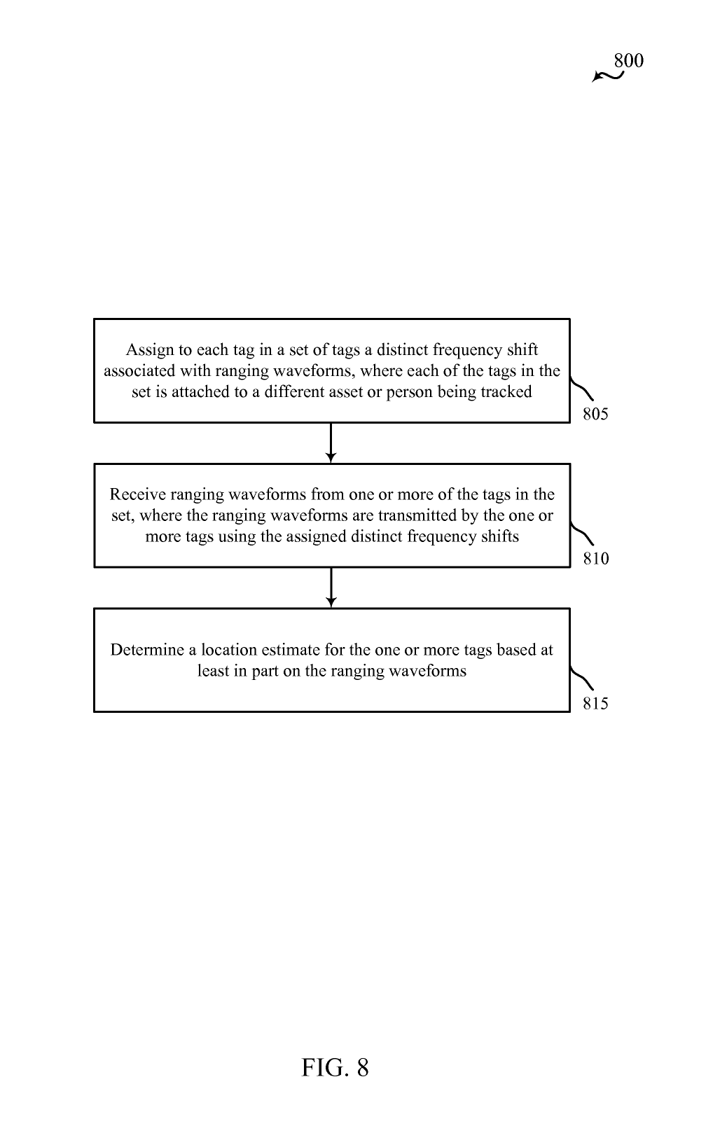

Turning next to FIG. 8, a flow diagram of a method 800 is shown for location tracking using distinct frequency shifts for each tag unit in accordance with various embodiments. The method 800 may be implemented using, for example, the devices 400 and 400-a of FIGS. 4A and 4B, respectively; the devices 600 and 600-a of FIG. 6A and FIG. 6B, respectively; the APs 105 of FIG. 1A, FIG. 1B, FIG. 3A, FIG. 3B, and FIG. 5; the tracking management servers 150 of FIG. 1A, FIG. 1B, and FIG. 7; and/or the system 100 of FIG. 1A and FIG. 1B.

At block 805, each tag (e.g., tag unit 115) in a set of tags is assigned a distinct frequency shift associated with ranging waveforms (e.g., transmissions 135), where each of the tags in the set is attached to a different asset or person being tracked.

At block 810, ranging waveforms are received from one or more of the tags in the set, where the ranging waveforms are transmitted by the one or more tags using the assigned distinct frequency shifts.

At block 815, a location estimate is determined for the one or more tags based at least in part on the ranging waveforms.

In some embodiments of the method 800, one or more UWB signals are received that include the ranging waveforms. In some embodiments, the distinct frequency shift assigned to each of the tags in the set is based on a total number of tags in the set. In some embodiments, the ranging waveforms are concurrently received during a specified time slot assigned to the tags in the set. In some embodiments, the frequency shift assigned to each of the tags in the set is based on the period of a PN sequence used in the ranging waveforms. The PN sequence corresponding to one of the tags in the set may be different from the PN sequence corresponding to another tag in the set. In some embodiments, the frequency shift assigned to each of the tags in the set is inversely proportional to a period of the ranging waveforms.

In some embodiments of the method 800, the set of tags corresponds to a first specified time slot, and a different set of tags corresponds to a second specified time slot different from the first specified time slot.

In some embodiments of the method 800, determining the location estimate for the one or more tags includes identifying an earliest path corresponding to one of the one or more tags based at least in part on the ranging waveforms received from that tag, determining a ranging measurement corresponding to the one tag based at least in part on the identified earliest path, and determining the location estimate for the one tag based at least in part on the ranging measurement.

In some embodiments of the method 800, the method further includes identifying a change in the number of tags in the set, and assigning to each tag in the set a new distinct frequency shift associated with the ranging waveforms, where each new distinct frequency shift is based at least in part on the identified change in the number of tags.

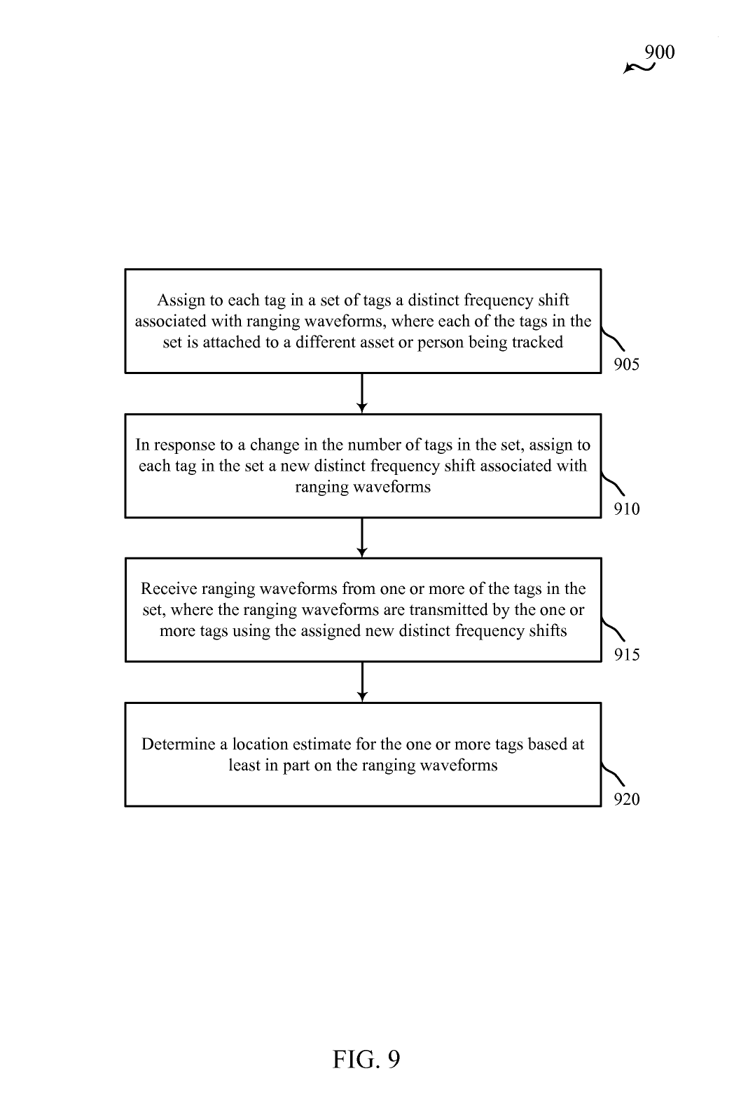

FIG. 9 shows a flow diagram of a method 900 for location tracking using distinct frequency shifts for each tag unit in accordance with various embodiments. The method 900, like the method 800 above, may be implemented using, for example, the devices 400 and 400-a of FIGS. 4A and 4B, respectively; the devices 600 and 600-a of FIG. 6A and FIG. 6B, respectively; the APs 105 of FIG. 1A, FIG. 1B, FIG. 3A, FIG. 3B, and FIG. 5; the tracking management servers 150 of FIG. 1A, FIG. 1B, and FIG. 7; and/or the system 100 of FIG. 1A and FIG. 1B.

At block 905, each tag (e.g., tag unit 115) in a set of tags is assigned a distinct frequency shift associated with ranging waveforms (e.g., transmissions 135), where each of the tags in the set is attached to a different asset or person being tracked.

At block 910, in response to a change in the number of tags in the set, each tag is assigned a new distinct frequency shift associated with ranging waveforms.

At block 915, ranging waveforms are received from one or more of the tags in the set, where the ranging waveforms are transmitted by the one or more tags using the assigned new distinct frequency shift.

At block 920, a location estimate is determined for the one or more tags based at least in part on the ranging waveforms.

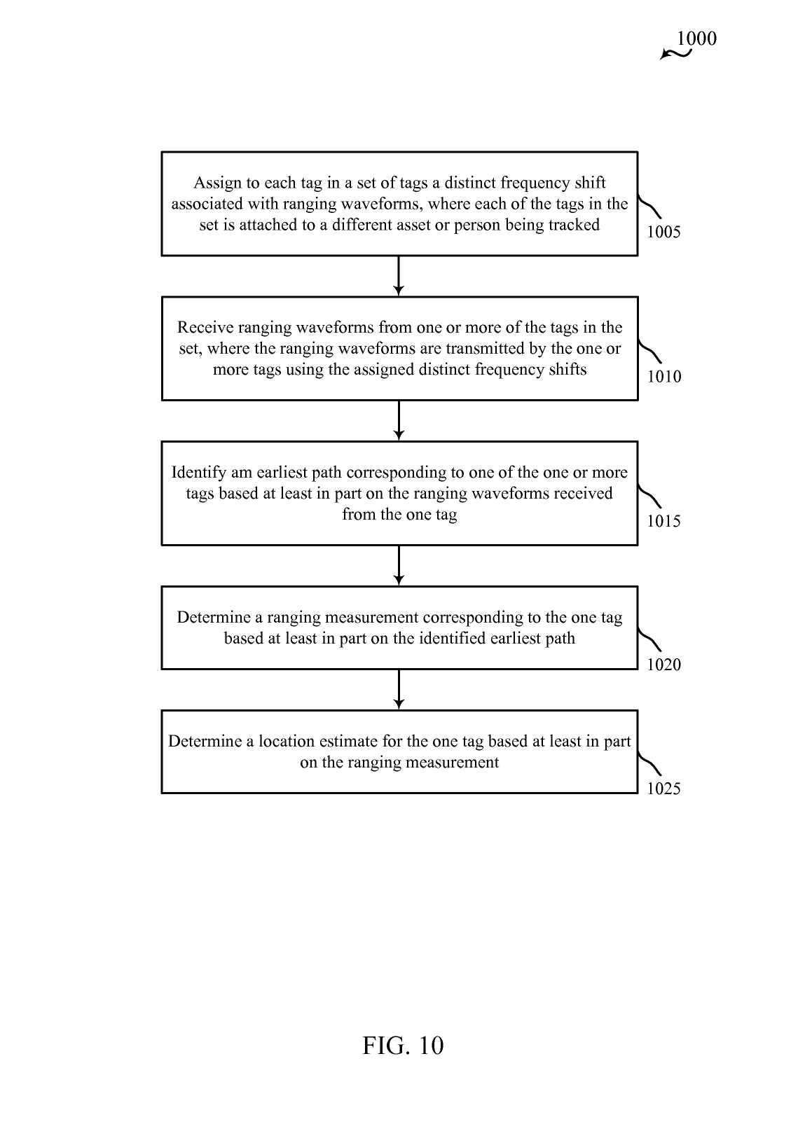

FIG. 10 shows a flow diagram of a method 1000 for location tracking using distinct frequency shifts for each tag unit in accordance with various embodiments. The method 1000, like the methods 900 and 800 above, may be implemented using, for example, the devices 400 and 400-a of FIGS. 4A and 4B, respectively; the devices 600 and 600-a of FIG. 6A and FIG. 6B, respectively; the APs 105 of FIG. 1A, FIG. 1B, FIG. 3A, FIG. 3B, and FIG. 5; the tracking management servers 150 of FIG. 1A, FIG. 1B, and FIG. 7; and/or the system 100 of FIG. 1A and FIG. 1B.

At block 1005, each tag (e.g., tag unit 115) in a set of tags is assigned a distinct frequency shift associated with ranging waveforms (e.g., transmissions 135), where each of the tags in the set is attached to a different asset or person being tracked.

At block 1010, ranging waveforms are received from one or more of the tags in the set, where the ranging waveforms are transmitted by the one or more tags using the assigned distinct frequency shifts.

At block 1015, an earliest path is identified corresponding to one of the one or more tags based at least in part on the ranging waveforms received from the one tag.

At block 1020, a ranging measurement corresponding to the one tag is determined based at least in part on the identified earliest path.

At block 1025, a location estimate is determined for the one tag based at least in part on the ranging measurement.

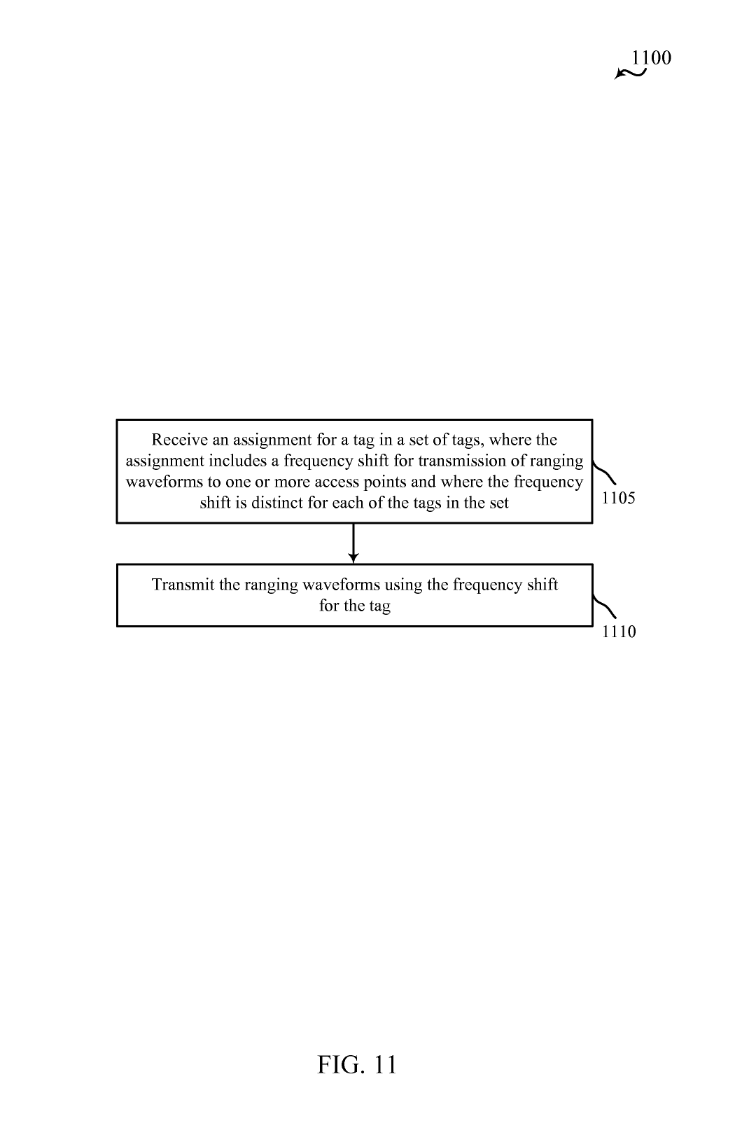

Turning next to FIG. 11, a flow diagram of a method 1100 is shown using a distinct frequency shift in a tag unit in accordance with various embodiments. The method 1100 may be implemented using, for example, the devices 200 and 200-a of FIGS. 2A and 2B, respectively; the tag units 115 of FIG. 1A, FIG. 1B, FIG. 3A, FIG. 3B, and FIG. 5; and/or the system 100 of FIG. 1A and FIG. 1B.

At block 1105, an assignment for a tag in a set of tags (e.g., tag unit 115) is received, where the assignment includes a frequency shift for transmission of ranging waveforms to one or more access points and where the frequency shift is distinct for each of the tags in the set.

At block 1110, ranging waveforms (e.g., transmissions 135) are transmitted using the frequency shift. In some embodiments, one or more UWB signals are transmitted that include the ranging waveforms.

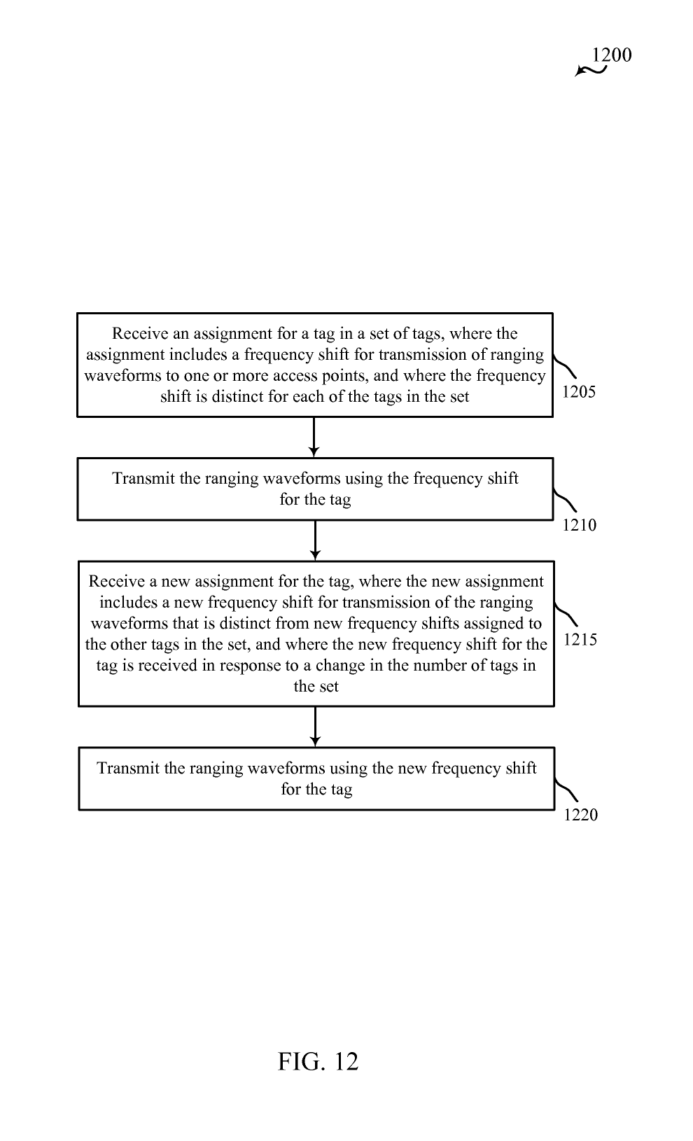

FIG. 12 shows a flow diagram of a method 1200 for using a distinct frequency shift in a tag unit in accordance with various embodiments. The method 1200, like the method 1100 above, may be implemented using, for example, the devices 200 and 200-a of FIGS. 2A and 2B, respectively; the tag units 115 of FIG. 1A, FIG. 1B, FIG. 3A, FIG. 3B, and FIG. 5; and/or the system 100 of FIG. 1A and FIG. 1B.

At block 1205, an assignment for a tag in a set of tags (e.g., tag unit 115) is received, where the assignment includes a frequency shift for transmission of ranging waveforms to one or more access points and where the frequency shift is distinct for each of the tags in the set.

At block 1210, ranging waveforms (e.g., transmissions 135) are transmitted using the frequency shift. In some embodiments, one or more UWB signals are transmitted that include the ranging waveforms.

At block 1215, a new assignment for the tag is received, where the new assignment includes a new frequency shift for transmission of the ranging waveforms that is distinct from new frequency shifts assigned to the other tags in the set, and where the new frequency shift for the tag is received in response to a change in the number of tags in the set.

At block 1220, ranging waveforms are transmitted using the new frequency shift for the tag. One or more UWB signals may be transmitted that include the ranging waveforms transmitted using the new frequency shift.

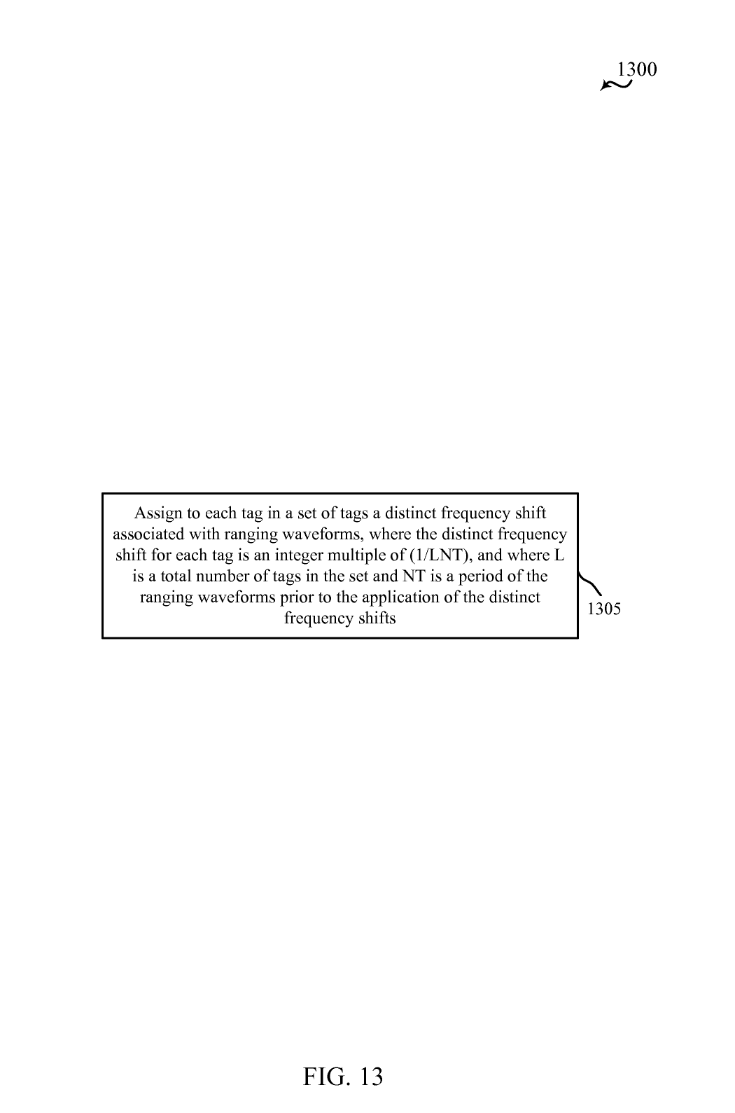

Turning next to FIG. 13, a flow diagram of a method 1300 is shown for assigning distinct frequency shifts to multiple tags in accordance with various embodiments. The method 1300 may be implemented using, for example, the devices 400 and 400-a of FIGS. 4A and 4B, respectively; the devices 600 and 600-a of FIG. 6A and FIG. 6B, respectively; the APs 105 of FIG. 1A, FIG. 1B, FIG. 3A, FIG. 3B, and FIG. 5; the tracking management servers 150 of FIG. 1A, FIG. 1B, and FIG. 7; and/or the system 100 of FIG. 1A and FIG. 1B.

At block 1305, each tag in a set of tags (e.g., tag units 115) is assigned a distinct frequency shift associated with ranging waveforms, where the distinct frequency shift for each tag is an integer multiple of (1/LNT), and where L is a total number of tags in the set and NT is a period of the ranging waveforms prior to the application of the distinct frequency shifts (see, e.g., equation (5)).

In some embodiments of the method 1300, a new distinct frequency shift is assigned to each tag in the set in response to a change in the total number of tags in the set. That is, when (1/LNT) changes because L changes, each tag in the set is assigned a new frequency shift.

The detailed description set forth above in connection with the appended drawings describes exemplary embodiments and does not represent the only embodiments that may be implemented or that are within the scope of the claims. The term “exemplary” when used in this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for location tracking, comprising:
assigning to each tag in a set of tags a distinct frequency shift associated with ranging waveforms, each of the tags in the set being attached to a different asset or person being tracked;
receiving the ranging waveforms from one or more of the tags in the set, the ranging waveforms being transmitted by the one or more tags using the assigned distinct frequency shifts; and
determining a location estimate for the one or more tags based at least in part on the ranging waveforms.

2. The method of claim 1, further comprising:
receiving one or more ultra-wideband (UWB) signals comprising the ranging waveforms.

3. The method of claim 1, wherein the distinct frequency shift assigned to each of the tags in the set is based on a total number of tags in the set.

4. The method of claim 1, wherein the ranging waveforms are concurrently received during a specified time slot assigned to the tags in the set.

5. The method of claim 1, wherein the frequency shift assigned to each of the tags in the set is based on a period of a pseudo-random noise (PN) sequence used in the ranging waveforms.

6. The method of claim 4, wherein the PN sequence corresponding to one of the tags in the set is different from the PN sequence corresponding to another tag in the set.

7. The method of claim 1, wherein the frequency shift assigned to each of the tags in the set is inversely proportional to a period of the ranging waveforms.

8. The method of claim 1, wherein:
the set of tags corresponds to a first specified time slot, and
a different set of tags corresponds to a second specified time slot different from the first specified time slot.

9. The method of claim 1, wherein determining the location estimate for the one or more tags comprises:
identifying an earliest path corresponding to one of the one or more tags based at least in part on the ranging waveforms received from the one tag;
determining a ranging measurement corresponding to the one tag based at least in part on the identified earliest path; and
determining the location estimate for the one tag based at least in part on the ranging measurement.

10. The method of claim 1, further comprising:
identifying a change in the number of tags in the set; and
assigning to each tag in the set a new distinct frequency shift associated with the ranging waveforms, each new distinct frequency shift being based at least in part on the identified change in the number of tags.

11. A method for location tracking, comprising:
receiving an assignment for a tag in a set of tags, the assignment comprising a frequency shift for transmission of ranging waveforms to one or more access points, and the frequency shift being distinct for each of the tags in the set; and
transmitting the ranging waveforms using the frequency shift for the tag.

12. The method of claim 11, wherein transmitting the ranging waveforms comprises:
transmitting one or more ultra-wideband (UWB) signals comprising the ranging waveforms.

13. The method of claim 11, further comprising:
receiving a new assignment for the tag, the new assignment comprising a new frequency shift for transmission of the ranging waveforms that is distinct from new frequency shifts assigned to the other tags in the set, and the new frequency shift for the tag being received in response to a change in the number of tags in the set; and
transmitting the ranging waveforms using the new frequency shift for the tag.

14. A method for location tracking, comprising:
assigning to each tag in a set of tags a distinct frequency shift associated with ranging waveforms, wherein the distinct frequency shift for each tag is an integer multiple of (1/LNT), and wherein L is a total number of tags in the set and NT is a period of the ranging waveforms prior to the application of the distinct frequency shifts.

15. The method of claim 14, further comprising:
assigning a new distinct frequency shift to each tag in the set in response to a change in the total number of tags in the set.

16. An apparatus for location tracking, comprising:
means for assigning to each tag in a set of tags a distinct frequency shift associated with ranging waveforms, each of the tags in the set being attached to a different asset or person being tracked;
means for receiving the ranging waveforms from one or more of the tags in the set, the ranging waveforms being transmitted by the one or more tags using the assigned distinct frequency shifts; and
means for determining a location estimate for the one or more tags based at least in part on the ranging waveforms.

17. The apparatus of claim 16, further comprising:
means for receiving one or more ultra-wideband (UWB) signals comprising the ranging waveforms.

18. The apparatus of claim 16, wherein the distinct frequency shift assigned to each of the tags in the set is based on a total number of tags in the set.

19. The apparatus of claim 16, wherein the ranging waveforms are concurrently received during a specified time slot assigned to the tags in the set.

20. The apparatus of claim 16, wherein the frequency shift assigned to each of the tags in the set is based on a period of a pseudo-random noise (PN) sequence used in the ranging waveforms.

21. The apparatus of claim 20, wherein the PN sequence corresponding to one of the tags in the set is different from the PN sequence corresponding to another tag in the set.

22. The apparatus of claim 16, wherein the frequency shift assigned to each of the tags in the set is inversely proportional to a period of the ranging waveforms.

23. The apparatus of claim 16, wherein:
the set of tags corresponds to a first specified time slot, and
a different set of tags corresponds to a second specified time slot different from the first specified time slot.

24. The apparatus of claim 16, wherein the means for determining the location estimate for the one or more tags comprises:
means for identifying an earliest path corresponding to one of the one or more tags based at least in part on the ranging waveforms received from the one tag;
means for determining a ranging measurement corresponding to the one tag based at least in part on the identified earliest path; and
means for determining the location estimate for the one tag based at least in part on the ranging measurement.

25. The apparatus of claim 16, further comprising:
means for identifying a change in the number of tags in the set; and
means for assigning to each tag in the set a new distinct frequency shift associated with the ranging waveforms, each new distinct frequency shift being based on the identified change in the number of tags.

26. An apparatus for location tracking, comprising:
means for receiving an assignment for a tag in a set of tags, the assignment comprising a frequency shift for transmission of ranging waveforms to one or more access points, and the frequency shift being distinct for each of the tags in the set; and
means for transmitting the ranging waveforms using the frequency shift for the tag.

27. The apparatus of claim 26, wherein the means for transmitting the ranging waveforms comprises:
means for transmitting one or more ultra-wideband (UWB) signals comprising the ranging waveforms.

28. The apparatus of claim 26, further comprising:
means for receiving a new assignment for the tag, the new assignment comprising a new frequency shift for transmission of the ranging waveforms that is distinct from new frequency shifts assigned to the other tags in the set, and the new frequency shift for the tag being received in response to a change in the number of tags in the set; and
means for transmitting the ranging waveforms using the new frequency shift for the tag.

29. An apparatus for location tracking, comprising:
means for assigning to each tag in a set of tags a distinct frequency shift associated with ranging waveforms, wherein the distinct frequency shift for each tag is an integer multiple of (1/LNT), and wherein L is a total number of tags in the set and NT is a period of the ranging waveforms prior to the application of the distinct frequency shifts.

30. The apparatus of claim 29, further comprising:
means for assigning a new distinct frequency shift to each tag in the set in response to a change in the total number of tags in the set.

31. A system for location tracking, comprising:
one or more access points configured to receive ranging waveforms from one or more tags in a set of tags, the ranging waveforms being transmitted by the one or more tags using a distinct frequency shift assigned to each of the tags in the set; and
a server configured to:
assign to each tag in the set the distinct frequency shift associated with ranging waveforms; and
determine a location estimate for the one or more tags based at least in part on the ranging waveforms received by the one or more access points.

32. The system of claim 31, wherein the one or more access points are configured to receive one or more ultra-wideband (UWB) signals comprising the ranging waveforms.

33. The system of claim 31, wherein the distinct frequency shift assigned to each of the tags in the set is based on a total number of tags in the set.

34. The system of claim 31, wherein the ranging waveforms are concurrently received during a specified time slot assigned to the tags in the set.

35. The system of claim 31, wherein the frequency shift assigned to each of the tags in the set is based on a period of a pseudo-random noise (PN) sequence used in the ranging waveforms.

36. The system of claim 35, wherein the PN sequence corresponding to one of the tags in the set is different from the PN sequence corresponding to another tag in the set.

37. The system of claim 31, wherein the frequency shift assigned to each of the tags in the set is inversely proportional to a period of the ranging waveforms.

38. The system of claim 31, wherein:
the set of tags corresponds to a first specified time slot, and
a different set of tags corresponds to a second specified time slot different from the first specified time slot.

39. The system of claim 31, wherein the server, the one or more access points, or both are further configured to:
identify an earliest path corresponding to one of the one or more tags based at least in part on the ranging waveforms received from the one tag;
determine a ranging measurement corresponding to the one tag based at least in part on the identified earliest path; and
determine the location estimate for the one tag based at least in part on the ranging measurement.

40. The system of claim 31, wherein the server is further configured to:
identify a change in the number of tags in the set; and
assign to each tag in the set a new distinct frequency shift associated with the ranging waveforms, each new distinct frequency shift being based at least in part on the identified change in the number of tags.

41. A device for location tracking, comprising:
a ranging module configured to receive an assignment for a tag in a set of tags, the assignment comprising a frequency shift for transmission of ranging waveforms to one or more access points, and the frequency shift being distinct for each of the tags in the set; and
a transmitter module configured to transmit the ranging waveforms using the frequency shift for the tag.

42. The device of claim 41, wherein the transmitter is configured to transmit one or more ultra-wideband (UWB) signals comprising the ranging waveforms.

43. The device of claim 41, wherein:
the ranging module is configured to receive a new assignment for the tag, the new assignment comprising a new frequency shift for transmission of the ranging waveforms that is distinct from new frequency shifts assigned to the other tags in the set, and the new frequency shift for the tag being received in response to a change in the number of tags in the set; and
the transmitter module is configured to transmit the ranging waveforms using the new frequency shift for the tag.

44. A computer program product for location tracking, comprising:
a non-transitory computer-readable medium comprising:
code for causing at least one computer to assign to each tag in a set of tags a distinct frequency shift associated with ranging waveforms, each of the tags in the set being attached to a different asset or person being tracked;
code for causing the at least one computer to receive the ranging waveforms from one or more of the tags in the set, the ranging waveforms being transmitted by the one or more tags using the assigned distinct frequency shifts; and
code for causing the at least one computer to determine a location estimate for the one or more tags based at least in part on the ranging waveforms.

45. The computer program product of claim 44, wherein the non-transitory computer-readable medium further comprises:
code for causing the at least one computer to receive one or more ultra-wideband (UWB) signals comprising the ranging waveforms.

46. The computer program product of claim 44, wherein the distinct frequency shift assigned to each of the tags in the set is based on a total number of tags in the set.

47. The computer program product of claim 44, wherein the ranging waveforms are concurrently received during a specified time slot assigned to the tags in the set.

48. The computer program product of claim 44, wherein the frequency shift assigned to each of the tags in the set is based on a period of a pseudo-random noise (PN) sequence used in the ranging waveforms.

49. The computer program product of claim 48, wherein the PN sequence corresponding to one of the tags in the set is different from the PN sequence corresponding to another tag in the set.

50. The computer program product of claim 44, wherein the frequency shift assigned to each of the tags in the set is inversely proportional to a period of the ranging waveforms.

51. The computer program product of claim 44, wherein:
the set of tags corresponds to a first specified time slot, and
a different set of tags corresponds to a second specified time slot different from the first specified time slot.

52. The computer program product of claim 44, wherein the non-transitory computer-readable medium further comprises:
code for causing the at least one computer to identify an earliest path corresponding to one of the one or more tags based at least in part on the ranging waveforms received from the one tag;
code for causing the at least one computer to determine a ranging measurement corresponding to the one tag based at least in part on the identified earliest path; and
code for causing the at least one computer to determine the location estimate for the one tag based at least in part on the ranging measurement.

53. The computer program product of claim 44, wherein the non-transitory computer-readable medium further comprises:
code for causing the at least one computer to identify a change in the number of tags in the set; and
code for causing the at least one computer to assign to each tag in the set a new distinct frequency shift associated with the ranging waveforms, each new distinct frequency shift being based at least in part on the identified change in the number of tags.

54. A computer program product for location tracking, comprising:
a non-transitory computer-readable medium comprising:
code for causing at least one computer to receive an assignment for a tag in a set of tags, the assignment comprising a frequency shift for transmission of ranging waveforms to one or more access points, and the frequency shift being distinct for each of the tags in the set; and
code for causing the at least one computer to transmit the ranging waveforms using the frequency shift for the tag.

55. The computer program product of claim 54, wherein the non-transitory computer-readable medium further comprises:
code for causing the at least one computer to transmit one or more ultra-wideband (UWB) signals comprising the ranging waveforms.

56. The computer program product of claim 54, wherein the non-transitory computer-readable medium further comprises:
code for causing the at least one computer to receive a new assignment for the tag, the new assignment comprising a new frequency shift for transmission of the ranging waveforms that is distinct from new frequency shifts assigned to the other tags in the set, and the new frequency shift for the tag being received in response to a change in the number of tags in the set; and
code for causing the at least one computer to transmit the ranging waveforms using the new frequency shift for the tag.
